(19) United States
(12) Patent Application Publication
(10) Pub. No.: US 2023/0419412 A1
(43) Pub. Date: Dec. 28, 2023

(54) METHODS AND SYSTEMS FOR A COLLAPSIBLE SIDEBAR

(71) Applicant: Government Employees Insurance Company (GEICO), Chevy Chase, MD (US)

(72) Inventors: Ronald Tyler Jordan, Mount Airy, MD (US); Shanshan Han, Cherry Hill, NJ (US); Leona Chan, Riverdale, MD (US); Michael Russell, Alexandria, VA (US); Alejandro De Jesus, Ellicott City, MD (US); Anna Riggs, Washington, DC (US); Dave Prescott, Bartow, FL (US); Carolyn Tran Shofstall, Winter Garden, FL (US); Rose Prince, Crofton, MD (US); Norah Fairfield, Fredericksburg, VA (US); Bobbi Baker, Fredericksburg, VA (US); Nuzhat Malik, Fairfax, VA (US); Joshua McCleary, Washington, DC (US); Jorge Raposo, Fredericksburg, VA (US); John Grabarczyk, II, Ellicott City, MD (US); William Foley, Bethesda, MD (US); Heather Moore Knight, Fredericksburg, VA (US)

(73) Assignee: Government Employees Insurance Company (GEICO), Chevy Chase, MD (US)

(21) Appl. No.: 18/212,365

(22) Filed: Jun. 21, 2023

Related U.S. Application Data
(60) Provisional application No. 63/355,261, filed on Jun. 24, 2022.

(51) Int. Cl. G06Q 40/08; G06F 3/0482

(52) U.S. Cl. CPC G06Q 40/08; G06F 3/0482

(57) ABSTRACT

The present invention consists of methods and systems for managing insurance services by allowing a user to adjust their insurance services using a collapsible sidebar. The invention generally consists of a user interface with a collapsible sidebar with a list of insurance services. The sidebar may also include an option to add or remove insurance protections. A user may select the option to add or remove insurance services. An interface may be shown to the user based on the selection. The interface may allow a user to update insurance services. A new quote may be provided to a user based on the updated insurance services.

### CROSS-REFERENCE TO RELATED APPLICATIONS

This application claims the benefit of priority to U.S. Provisional Patent Application No. 63/355,261, filed Jun. 24, 2022, the entire contents of which are hereby incorporated by reference.

### BACKGROUND

### Technical Field

The present disclosure generally relates to the field of managing user insurance registration by optimizing computational resources. More specifically, the present disclosure relates to systems, methods, and devices for providing a means to manage and organize users' insurance options with a collapsible virtual sidebar applet.

### Background Information

Over the years, vendors and service providers have made increasingly frequent use of online shopping platforms to sell their products or services. As these platforms have increased in popularity, virtual shopping carts have allowed online customers to manage their online purchases. These virtual shopping carts typically allow online customers to review, add, or remove products or services during one or more sessions on the online shopping platforms. Users of such online shopping platforms are confronted with multiple screens and navigational tools which create challenges for both the users and backend systems—challenges for the user to navigate through these platforms, and challenges to the backend systems for providing the various near-instantaneous options and applets, especially when a user is attempting to view or purchase multiple items.

Insurance providers, like many other vendors and service providers, have transitioned to marketing their insurance products on online shopping platforms. However, the nature of insurance (i.e., insurance coverage) makes the use of a virtual shopping cart less intuitive and a drain on computational resources. Importantly, insurance providers often need to run multiple iterations of inquiries collecting information from customers concerning various factors (e.g., user demographics, accident histories, credit histories) that may influence the insurance coverage (i.e., the offered prices, rates, or terms) at which their insurance products are offered. In addition, insurance providers may personalize or customize these insurance coverage terms further based on the concept of “bundling,” by which risk is reduced by analyzing insurance coverage collectively and prices or rates are likewise reduced when multiple insurance coverage products are purchased from the same insurance provider.

Although virtual shopping carts may allow users to review or remove the insurance coverage products selected with relative ease, they may not afford users the opportunity to easily navigate through the many questions that must be asked of them to determine final prices or rates for their products in the event that such users want to add or modify their selected products once an initial product has been selected (which further utilizes additional computational resources from the insurance provider). Instead, users may be forced to navigate to separate pages to make changes to their selected insurance products (which likewise utilizes computational resources in an inefficient manner). During this process, a user may not be able to easily return to the original webpage, or easily view items that are in a user's cart and the insurance provider backend system efficiency may be further impacted by this process.

In addition, purchasers of insurance products vary wildly in their familiarity with online shopping platforms. In some instances, purchasers of insurance products may not be adept at manipulating virtual shopping carts. In other instances, purchasers of insurance products may have difficulty navigating the varying structures of online shopping platforms. As a result, these purchasers of insurance products may be less likely to buy additional insurance products or change their current insurance plans.

Consequently, there is a need for a streamlined system that allows users to conveniently visualize, organize, and manage insurance products as they navigate insurance providers' online shopping platforms that further optimizes the backend system in tracking, computing, and analyzing the insurance coverage terms.

### SUMMARY

Embodiments consistent with the present disclosure provide systems, methods, and devices for providing a means to manage and organize users' online purchases using a collapsible virtual sidebar.

Some disclosed embodiments may include systems, methods, and non-transitory computer readable medium for providing a collapsible menu on a user interface. Some of these embodiments may involve displaying on a user interface a collapsible menu, wherein the collapsible menu includes at least one option to edit insurance-related products; receiving from a user a selection of the at least one option to edit insurance-related products; providing on the user interface a plurality of insurance-related products based on the selection of the at least one option to edit insurance-related products; receiving from the user a selection of at least one insurance-related product in the plurality of insurance-related products; updating the collapsible menu based on the selected at least one insurance-related product; determining a custom insurance service product for the user based on the selected at least one insurance-related product; and providing on the user interface information on the custom insurance service product.

In certain embodiments, the collapsible menu may expand in response to at least one of a user clicking on the collapsible menu or a pointer hovering over the collapsible menu.

In certain embodiments, updating the collapsible menu may comprise adding or removing at least one indicator representing the selected at least one insurance-related product within the collapsible menu. In certain embodiments, at least one indicator may comprise an icon. In certain embodiments, the collapsible menu may further display a second indicator based on historical data of the user. In certain embodiments, at least one insurance-related product may comprise a first insurance-related product, and the historical data of the user may comprise a second insurance-related product selected by the user.

In certain embodiments, the one or more processors may be further configured to execute the instructions to further include, upon receiving from the user the selection of the at least one insurance-related product in the plurality of insurance-related products, generate a questionnaire for customizing insurance service products based on the selected at least one insurance-related product; provide the questionnaire on the user interface; and receive a user input in response to the questionnaire.

In certain embodiments, the questionnaire may request information associated with at least one user insurance risk factor. In certain embodiments, the at least one user insurance risk factor may be associated with at least one of a demographic of the user, a location of the user, a residence of the user, a vehicle of the user, a credit history of the user, an accident report of the user, a police record of the user, an insurance history of the user, a record or report on a vehicle associated with the user, or a record or report on a residence associated with the user.

In certain embodiments, determining the custom insurance product may be further based on the receive user input.

Additionally, the disclosed embodiments may include non-transitory computer-readable media storing software instructions that, when executed by one or more processors, are configured to execute one or more of the methods, operations, processes, or functionalities exemplified above. Aspects of the disclosed embodiments may also be performed by one or more processors configured as special-purpose processor(s) that are programmed with logic and instructions that perform, when executed, one or more of the methods, operations, processes, or functionalities exemplified above.

It is to be understood that both the foregoing general description and the following detailed description are exemplary and explanatory only and are not restrictive of the disclosed embodiments, as claimed.

### BRIEF DESCRIPTION OF THE DRAWINGS

Some embodiments of the present invention are illustrated as an example and are not limited by the accompanying drawings.

FIG. 1 illustrates a user's experience interacting with a collapsible sidebar on a user interface to add, modify, and/or remove insurance-related products, selecting and deselecting insurance-related products, completing a questionnaire regarding newly selected insurance-related products, and obtaining a price quote for the newly selected insurance-related products.

FIGS. 2A-2H illustrate an exemplary system capable of carrying out the functionalities of the present invention.

FIGS. 3A-3G present a flow chart outlining processes by which a bundling module and included universal conversation engine may enable and/or disable display settings and/or bundling options, assess whether sufficient information is available to generate a price quote for selected insurance-related products, acquire additional information from a user through one or more questionnaires, and generate a price quote for selected insurance-related products.

FIGS. 4A-4E illustrate an expanded view of a collapsible sidebar. The sidebar may include an actionable chevron icon that controls the collapsibility of the sidebar. The collapsible sidebar may also include product icons that correspond to insurance-related products. The collapsible sidebar may include one or more actionable icons to add, edit, or remove insurance-related products.

FIGS. 5A-5P illustrate the functionality of a collapsible sidebar and the corresponding guidelines, as well as the processes by which a user may acquire an insurance payment plan through the user interface.

### DETAILED DESCRIPTION

Reference will now be made in detail to the disclosed embodiments, certain examples of which are illustrated in the accompanying drawings. One of ordinary skill in the art will recognize that, while the following detailed description sets forth many details to provide a thorough understanding of the disclosed embodiments, the processes and functionalities of the disclosed embodiments may be practiced without every specific detail. One of ordinary skill in the art will also recognize that the disclosed embodiments may be modified in various respects without departing from the spirit and scope of this disclosure. Accordingly, the drawings and descriptions are to be regarded as illustrative, and not restrictive, in nature. Unless explicitly stated, the exemplary methods, operations, processes, and functionalities described herein are constrained neither to a particular order or sequence nor to a particular configuration. Some of the described embodiments or elements thereof may occur or be performed simultaneously, at the same point in time, or concurrently. Wherever convenient, the same reference numbers will be used throughout the drawings to refer to the same or like parts.

The disclosed systems, methods, and non-transitory computer-readable media may be implemented in a network environment where a user, operating a computer, smart phone, tablet, or the like, is connected to a network, such as the Internet, and can establish a communication session with a server computer that provides one or more webpages or similar content relating to insurance information. The arrangement of functionalities and/or components set forth in the figures is not intended to limit the disclosed embodiments in any way, as the functionalities and/or components used in the disclosed methods, systems, and non-transitory computer-readable media may vary.

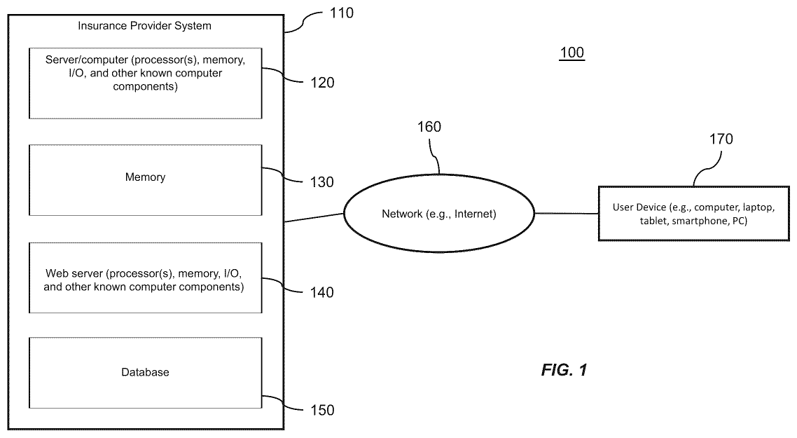

FIG. 1 presents a diagram illustrating an exemplary system 100 for providing a collapsible menu on a user interface consistent with certain disclosed embodiments. In certain embodiments, the collapsible menu may be used on an online shopping platform for insurance-related products. However, it is contemplated that the collapsible menu may be used for other types of online shopping platforms and products altogether. System 100 may include insurance provider system 110; server 120; memory 130; web server 140; database 150; network 160; and at least one user device 170.

Insurance provider system 110 may include one or more computing devices configured to perform one or more processes consistent with the disclosed embodiments. For example, insurance provider system 110 may include one or more computer or data processing devices having hardware (e.g., processors, storage memory, data buses, network interfaces) and/or software (e.g., application programs, operating systems, other executable program code written in one or more known programming languages). In certain embodiments, insurance provider system 110 may be configured to provide an online location (e.g., a website portal, webpage) for providing and marketing insurance-related products and associated information to customers, consistent with disclosed embodiments. Insurance provider system 110 may be configured to receive requests for information and/or provide information over a network, such as network 160. In some embodiments, insurance provider system 110 may be configured to receive information from and/or provide information to user device 170 via network 160. Insurance provider system 110 may include components, infrastructure, and other elements enabling insurance provider 115 to provide insurance-related products and associated information to customers, and to display and modify a collapsible menu based on user selections. For example, insurance provider system 110 may include one or more components (e.g., servers; processors; memory devices storing software instructions that, when executed by one or more processors, execute insurance-related processes; communication components). Insurance provider system 110 may include systems that are geographically separated (e.g., servers distributed geographically in one or more localities, counties, states, provinces, zones, regions, or countries). Insurance provider system 110 may reflect a central system (e.g., a central server) that serves other systems (e.g., client computers, remote servers). The configurations, architectures, and underlying network, hardware, and software components implemented by the one or more systems included in insurance provider system 110 are not intended to be limiting with respect to the features and processes of the disclosed embodiments.

In certain embodiments, insurance provider system 110 may include one or more servers (e.g., server 120), one or more memory devices (e.g., memory 130), and one or more web servers (e.g., web server 140). Server 120 and web server 140 may each include one or more processing devices, memory devices, input/output devices, and/or other known computer components. Server 120 and web server 140 may each include one or more processors configured to execute software instructions stored on one or more memory devices, such as memory 130. Web server 140 may include one or more web servers providing known web server operations and functions. Web server 140 may interface and communicate with server 120 in insurance provider system 110 to collect insurance information or user information. Web server 140 may store this information locally (e.g., in memory 130). Web server 140 may collect information from sources external to insurance provider system 110 (e.g., from sources not shown in system 100). Memory 130 may include one or more memory devices configured to store software instructions that, when executed by one or more processors, perform one or more processes consistent with disclosed embodiments.

In certain embodiments, insurance provider system 110 may include, be connected to, or be associated with database 150. Database 150 may include one or more computing devices configured to store historical data of a user. In certain embodiments, historical data may include insurance-related data associated with the user, such as information data with one or more of the user's already purchased insurance-related products, one or more insurance-related products the consumer has selected for purchase, one or more risk factors of the user, one or more demographics of the user, or other information. Database 150 may include one or more computing devices configured to provide historical data to other portions of insurance provider system 110, such as network 160 or user device 170. In certain embodiments, such data may include information presented by user during a concurrent or prior session on the online shopping platform.

Database 150 may include one or more structured or unstructured databases. For example, database 150 may include one or more Oracle™ databases, Sybase™ databases, or other relational or non-relational databases, such as Hadoop™ sequence files, HBase™, or Cassandra™. Database 150 may include computing components (e.g., database management system, database server) configured to receive and process requests for data stored in memory devices of database 150 and to provide data from database 150.

Insurance provider system 110 may be associated with one or more providers (e.g., insurance provider 115). In certain embodiments, insurance provider 115 may be an entity that provides insurance-related products to customers. In other embodiments, insurance provider 115 may be another kind of entity, such as a vendor or provider of one or more other types of goods and services. In certain embodiments, insurance provider system 110 may be associated with a general server system provider that hosts and/or facilitates one or more insurance provider systems 110 for insurance provider 115.

Network 160 may include a wireless and/or wired network components (e.g., hardware, software, firmware) configured to receive, route, translate, and deliver information. For example, network 160 may include the Internet, an extranet, an intranet, a Local Area Network, near-field communication (NFC), Bluetooth®, an optical code scanner, or other suitable connections and may include infrastructure that facilitates the communication of information over these types of networks (e.g., wireless/wired base stations, transceivers, and related devices). In certain embodiments, network 160 may include any type of communication network configured to transmit facilitate the exchange of information between the components of system 100. For example, network 160 may transmit information between insurance provider system 110 and user device 170. In certain embodiments, one or more components of system 100 may communicate directly over network 160 through one or more dedicated communication links.

User device 170 may be associated with a current insurance customer or a potential insurance customer. User device 170 may include one or more computing devices configured to perform known computer-based processes and communication functionalities (e.g., network communications and access). For example, user device 170 may include at least one of a desktop computer, a laptop, a server, a mobile device (e.g., tablet, smart phone), a gaming device, a wearable computing device, or any other type of computing device. User device 170 may include one or more processors and memory devices storing software instructions that, when executed by the computer processor(s), perform one or more operations consistent with the disclosed embodiments. User device 170 may also include components that provide communications with network 160 or other computing components of system 100. In certain embodiments, user device 170 may be configured to execute, via the one or more processors, software programs, applications, and other processes (e.g., e-mail, network communication, telephone, and texting software processes) that enable user device 170 to communicate with other remote devices. User device 170 may be capable of downloading and executing mobile applications, such as a mobile application that provides access to an online shopping platform provided by insurance provider system 110. It is understood, however, that a mobile application is not necessary for to access the online shopping platform, and that such online shopping platform may be accessible via, e.g., a web page.

User device 170 may be configured to connect to network 160 (e.g., the Internet) and/or insurance provider system 110. In certain embodiments, user device 170 may connect to insurance provider system 110 through a wireless connection to network 160. In other embodiments, user device 170 may connect to insurance provider system 110 through cloud-based computing technologies. In still other embodiments, user device 170 may connect insurance provider system 210 through a wired connection to network 160.

User device 170 may be configured to perform network communication and content-display processes. For example, user device 170 may execute Internet browser software that generates and displays content in one or more user interfaces (e.g., user interface 200, discussed below) included in, connected to, or associated with user device 170.

In certain embodiments, user device 170 may be associated with a user. A user may be a customer associated with an entity, such as an insurance provider or an account provider, that provides certain services for the user. A user may be a potential customer of an entity. In certain embodiments, the user may be an entity (e.g., a corporation, partnership, company, government agency, municipality, or other form of business or government entity) that obtains insurance for its employees or customers. In one embodiment, a user may be associated with the provider of insurance provider system 110. For example, the user may be an employee of an insurance provider that provides insurance provider system 110, and the employee may use user device 170 to access insurance provider system 110 to provide quotes for a policyholder or potential policyholder of the insurance company.

The disclosed embodiments are not limited to any particular configuration of user device 170. For instance, user device 170 can be a mobile device that stores and executes mobile applications that interact with one or more of insurance provider system 110, server 120, memory 130, web server 140, database 150, or network 160 to perform aspects of the disclosed embodiments.

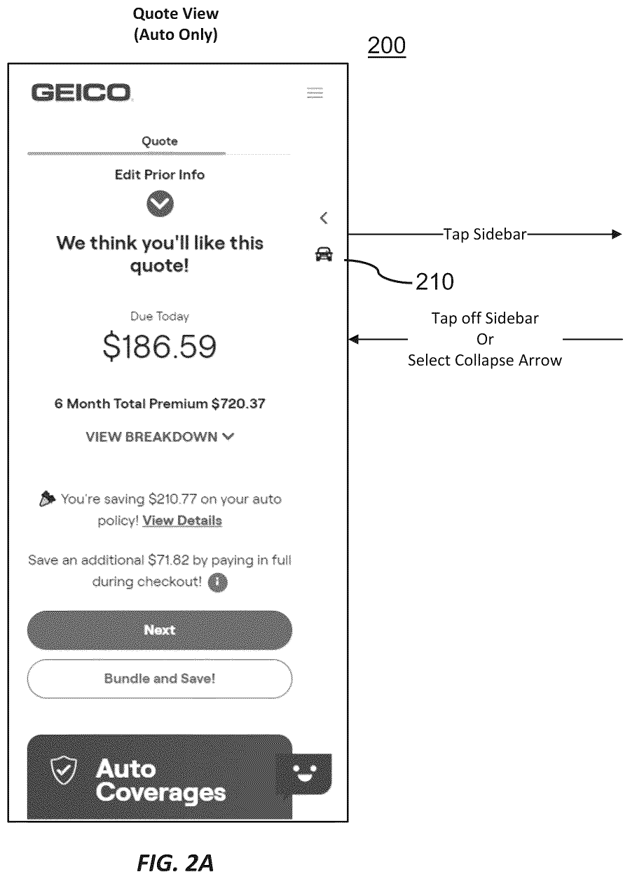

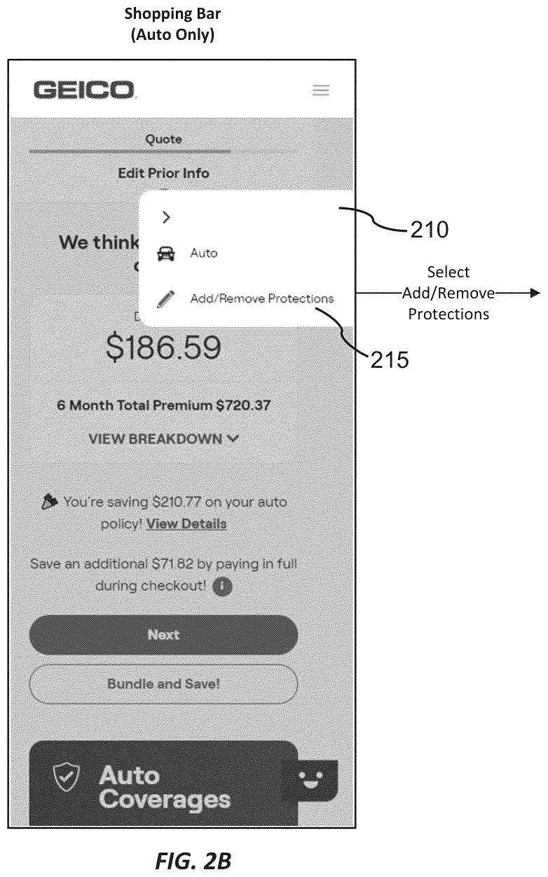

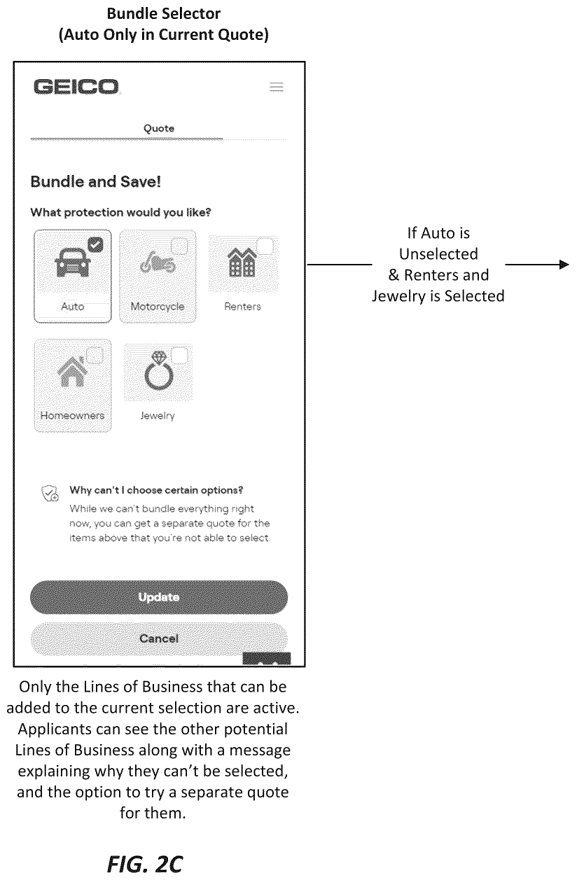

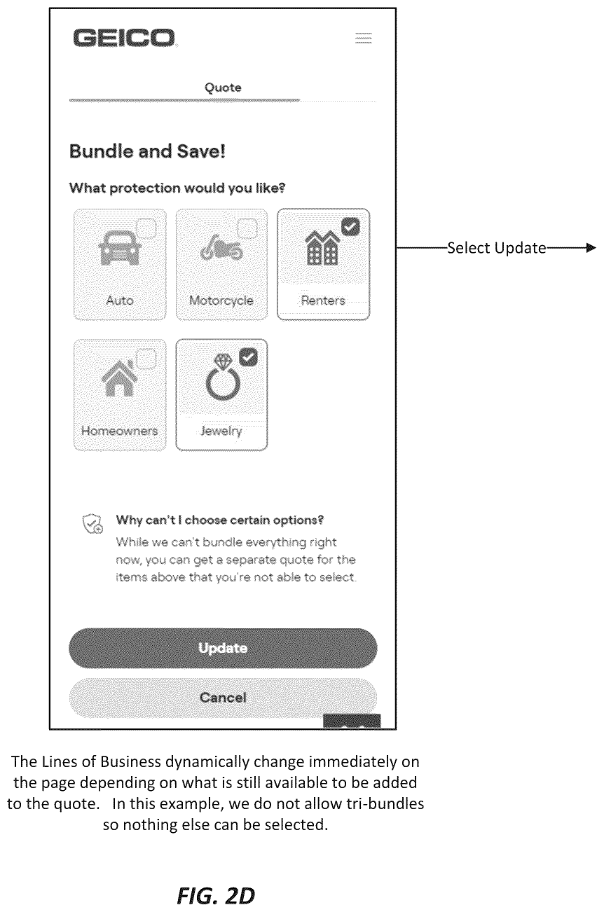

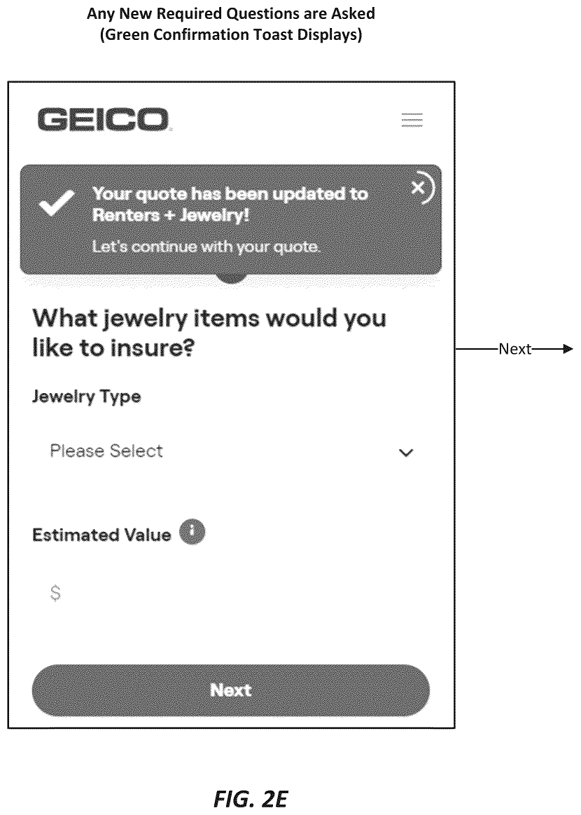

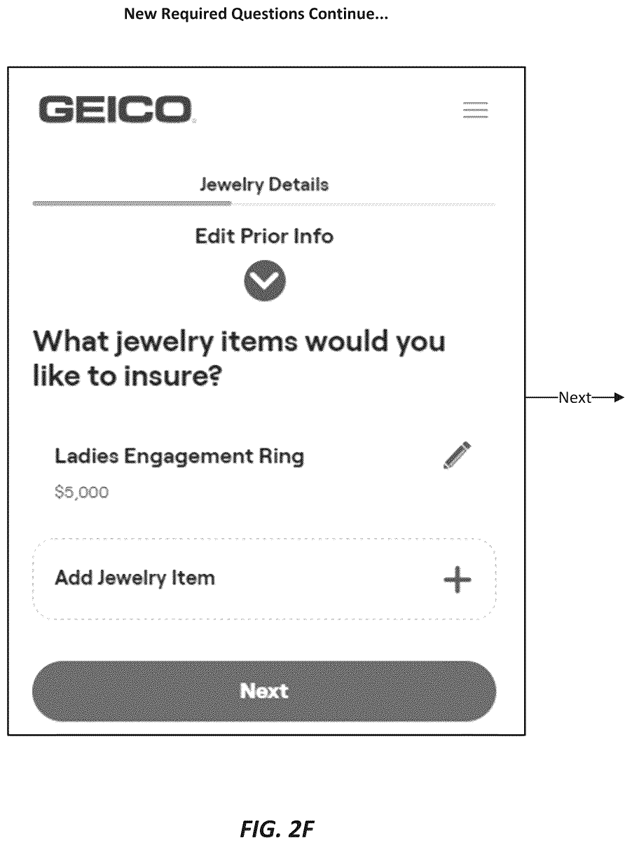

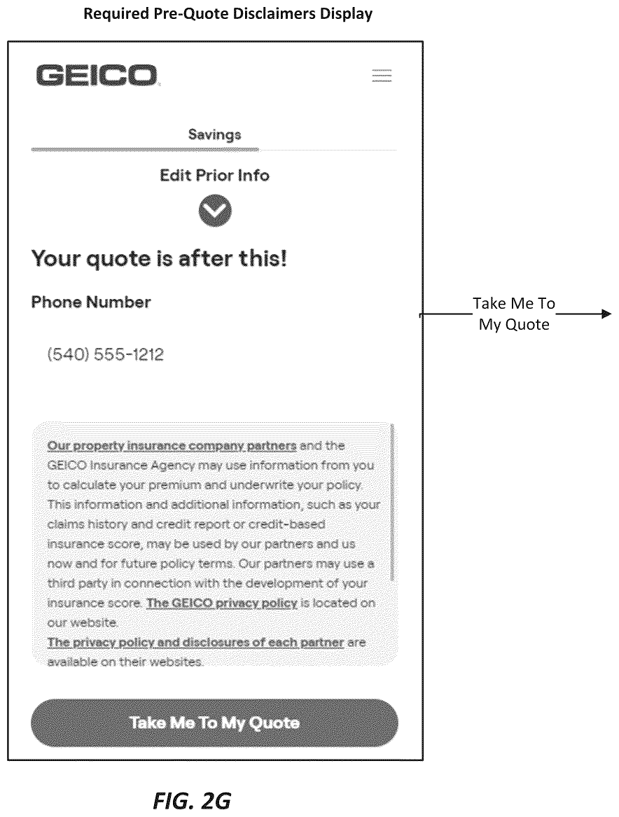

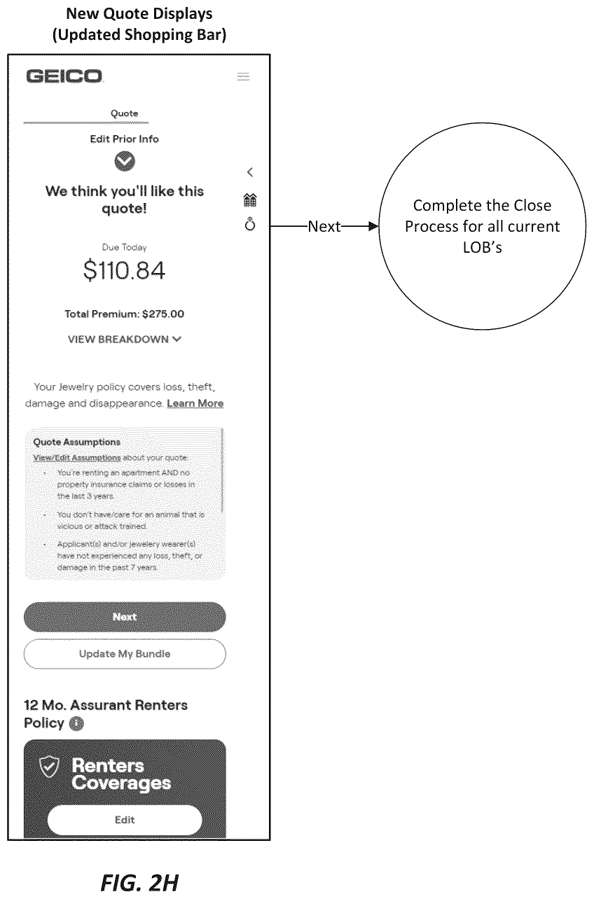

The disclosed embodiments provide methods, systems, and non-transitory computer-readable media for displaying a collapsible menu on a user interface, such as user interface 200 in FIGS. 2A and 2B. User interface 200 may include a means by which a user interacts with a computer system. For example, user interface 200 may include a touchscreen, computer screen, touchpad, virtual window, virtual screen, web browser, or any other type of device that allows a user to operate and control functions in a computer system. A collapsible menu 210 may include a list of options that can be selected by a user. Collapsible menu 210 may be displayed on user interface 200. Collapsible menu 210 may also be capable of being minimized. For example, a user may select an option to collapse collapsible menu 210 wherein collapsible menu 210 is no longer visible in user interface 200. In another embodiment, the size of collapsible menu 210 may be reduced, so collapsible menu 210 is still visible in user interface 200, but the size of collapsible menu 210 is smaller. In another embodiment, collapsible menu 210 may always be visible in user interface 200.

As shown in FIG. 2B, in certain embodiments, collapsible menu 210 may include at least one option to edit insurance-related products (“edit option”) 215. As used herein, the term “insurance-related products” refers to goods and services associated with the practice of providing one or more guarantees or compensation for one or more specified losses or instances of damage, illness, or death in return for payment of a premium. Such goods and services may include, for example, homeowner's insurance policies, renter's insurance policies, automobile insurance policies, motorcycle insurance policies, jewelry insurance policies, fire insurance policies, flood insurance policies, life insurance policies, or other types of policies. Such goods and services may be associated with one or more policyholders, wherein the policyholders may comprise primary policyholders and/or secondary policy holders. In some embodiments, collapsible menu 210 may include a means to change such insurance-related products. For example, collapsible menu 210 may display insurance-related products. Collapsible menu 210 may display a single product or multiple products.

In certain embodiments, system 100 may receive from a user a selection of at least one option to edit insurance-related products. For example, within collapsible menu 210, a user may select edit option 215. The user may select edit option 215 using a computer mouse, keypad, stylus, the user's finger, or any other means. Edit option 215 may an include option to add an insurance-related product. Edit option 215 may also include an option to remove insurance-related products. As another example, edit option 215 may include an option to increase or decrease an insurance amount associated with an insurance-related product. As another example, edit option 215 may include an option to add and/or remove a policyholder associated with an insurance-related product. As another example, edit option 215 may include changing the estimated value of a protectable item covered by an insurance-related product. For example, a user may have homeowner's insurance. A price of the owner's home may increase, and a user may update this information using user interface 200.

As shown in FIGS. 2C and 2D, system 100 may be configured to display, on user interface 200, a plurality of insurance-related products based on the user's selection of edit option 215. The plurality of insurance-related products may include, for example, homeowner's insurance policies, renter's insurance policies, automobile insurance policies, motorcycle insurance policies, jewelry insurance policies, fire insurance policies, flood insurance policies, life insurance policies, or other types of insurance policies. The plurality of insurance-related products may be displayed as a textual list; as a set of icons, photographs, or other graphics; or in any other format.

A user may select one or more insurance-related products from the displayed plurality of insurance-related products via user interface 200 in order to edit details related to one or more insurance-related products. For example, a user may select automobile insurance from the plurality of insurance-related products. As another example, a user may select renter's insurance and jewelry insurance from the plurality of insurance-related products. In certain embodiments, a user may deselect one or more insurance-related products via user interface 200. For example, a user may be directed to a screen that displays a plurality of insurance-related products, one or more of which may already be selected based on a user's current insurance service(s). For example, a user may already have automobile insurance, and this selection may appear in the plurality of insurance-related products displayed on user interface 200. A user may deselect the automobile insurance option. Upon selecting and/or deselecting one or more specific types of insurance via user interface 200, the user may then be directed to a screen that allows a user to update the specific insurance options selected, which may display in user interface 200.

As shown in FIGS. 2E and 2F, once the user selects one or more specific types of insurance service, user interface 200 may display questions related to the selected type(s) of insurance service. A universal conversation engine (“UCE”) (e.g., universal conversation engine 350 or UCE 350, discussed below) may create specific questions based on the selected type(s) of insurance service. For example, a user may select automobile insurance. The user may then be directed to a screen that displays questions related to the user's automobile insurance. These questions may include questions concerning service amount, vehicle type, monthly payment, or other options. A user may change any of these options via user interface 2100. As another example, a user may select jewelry insurance. The user may then be directed to a screen that may display questions related to the user's jewelry insurance. These questions may include questions concerning the type of jewelry, the estimated value of the jewelry, or other questions related to jewelry insurance. A user may respond to these questions via user interface 200.

System 100 may include a bundling module 300 (discussed below), which may determine a price quote based on the specific type(s) of insurance service a user has selected or deselected. As shown in FIG. 2H, the price quote may then be displayed to the user. In certain embodiments, bundling module 300 may require further input from the user before causing user interface 200 to display the price quote. For example, bundling module 300 may cause UCE 350 (discussed below) to prompt the user, via user interface 200, to input personal information, such as a phone number, email address, or other data, and/or select an option to display the price quote, as shown in FIG. 2G.

Additional screens may be displayed for a user via user interface 200. The additional screens may include an option to further edit an insurance service, an option to finalize an insurance change, or other types of information.

In certain embodiments, system 100 may update collapsible menu 210 based on the user's selection of at least one insurance-related product. For example, a user may select jewelry insurance. As a result, system 100 may add jewelry insurance as an option on the collapsible menu. As another example, a user may select renter's insurance, and system 100 may add renter's insurance as an option on the collapsible menu.

In certain embodiments, system 100 may determine a custom insurance service product for the user based on the selected at least one insurance-related product. A custom insurance service product may be a product that is related to a specific insurance type. For example, a user may select jewelry insurance. A custom insurance service product may include insurance for a wedding ring. As another example, a custom insurance service product may include insurance for a watch. In another instance, a user may select car insurance. A custom insurance service product may include collision coverage. As another example, a custom insurance service product may include liability coverage. System 100 may determine the custom insurance product based wholly or partially on the user's responses to questions created by UCE 350 and displayed via user interface 200.

In certain embodiments, a system may provide information on the custom insurance service product on user interface 200. For example, the information related to the custom insurance service product may include type, cost, length of time of coverage, or any other information related to the custom insurance product. For example, a custom insurance service product may be liability coverage. Information related to liability coverage may include the cost of the coverage for a month. As another example, a custom insurance service product may be jewelry insurance for a wedding ring. Information related to the wedding ring may be the estimated value of the ring.

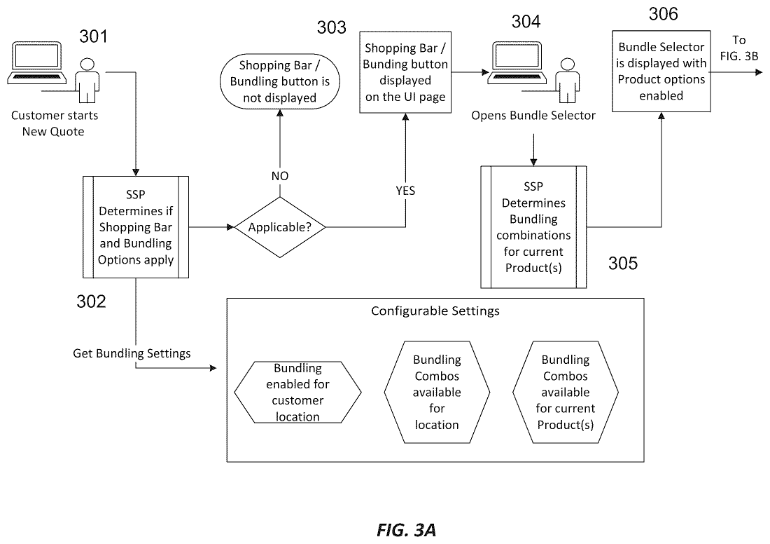

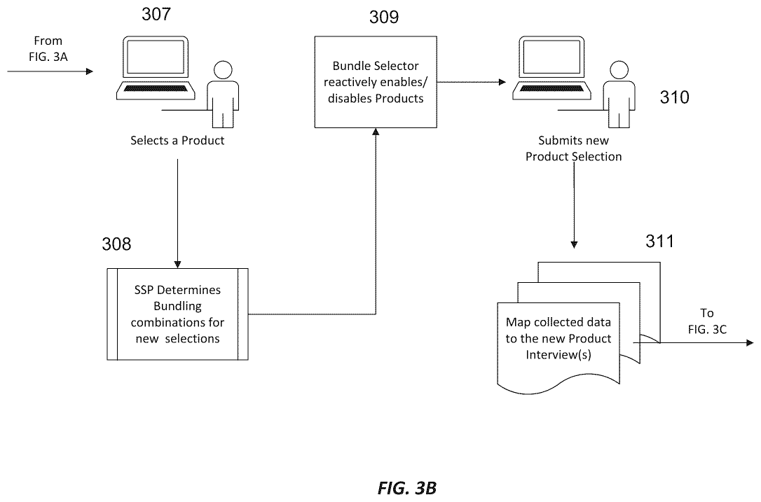

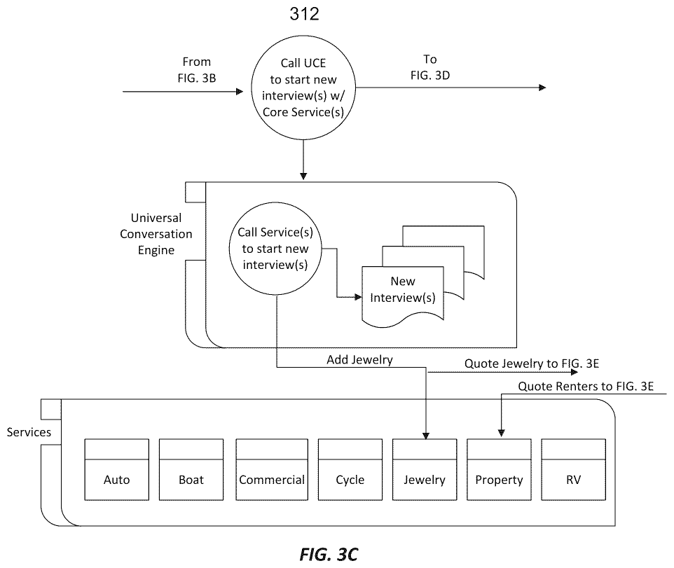

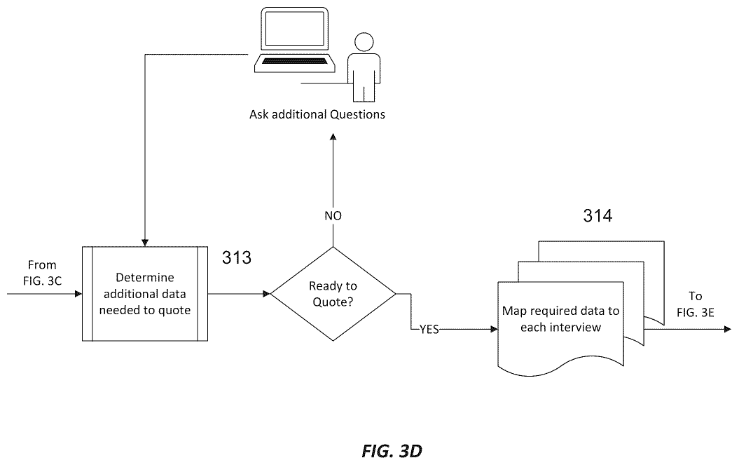

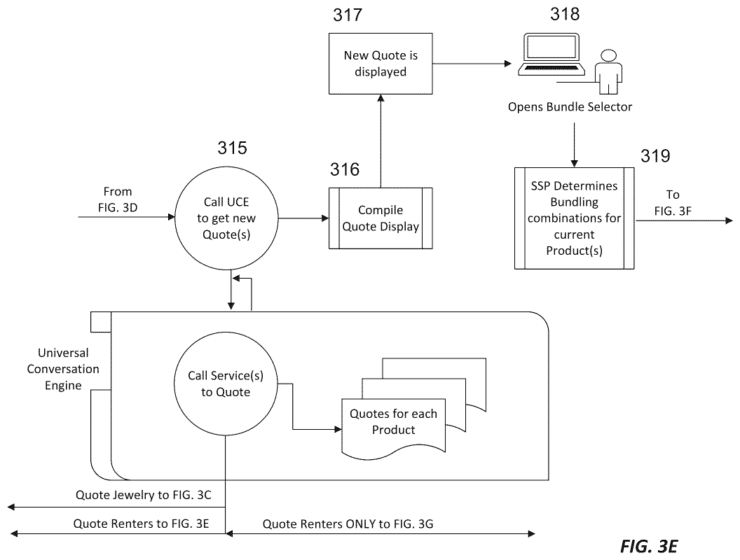

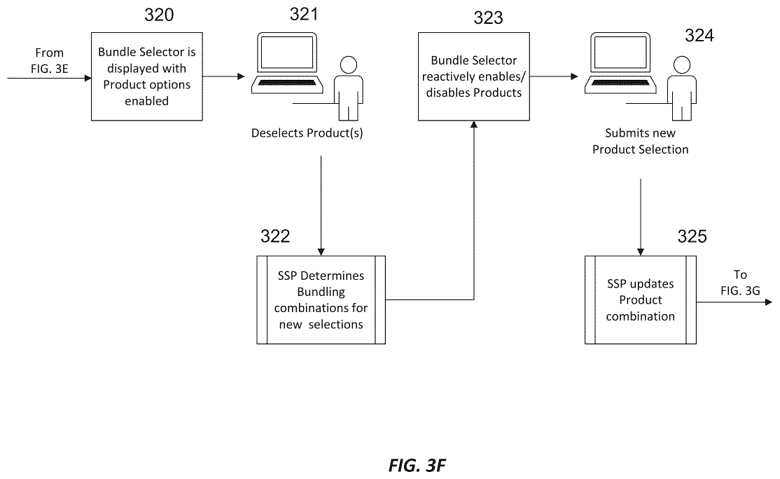

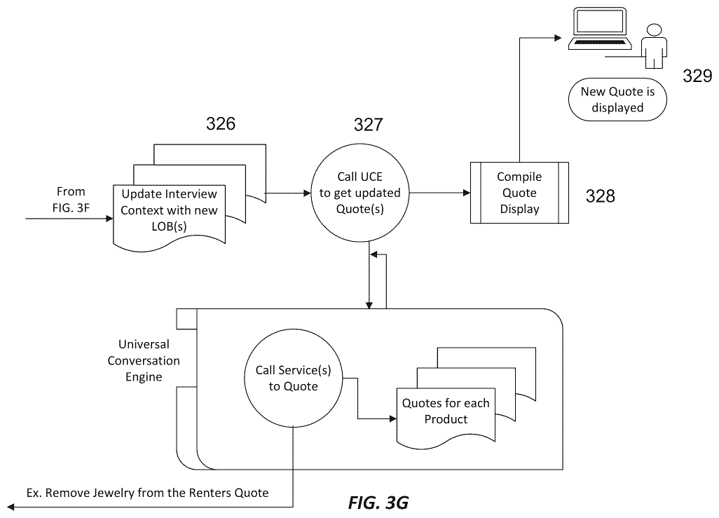

FIGS. 3A-3G present a flowchart of an exemplary product selection, bundling, and price quote generation process consistent with disclosed embodiments.

In step 301, a user may access an online shopping platform for insurance-related products hosted by an insurance provider (e.g., insurance provider 115). For example, the user may manipulate user device 170 to communicate with insurance provider system 110 over network 160 (e.g., the Internet). In response to this communication, insurance provider system 110 may identify a web site or other online shopping platform where the insurance provider 115 markets its insurance-related products. User device 170 may then execute Internet browser software to generate and display the website or other online shopping platform in one or more user interfaces (e.g., user interface 200) included in, connected to, or associated with user device 170.

Upon accessing the online shopping platform, the user may initiate a process for generating a new price quote for one or more insurance-related products. For example, a user may select an option on user interface 200 to request or build a new price quote for one or more insurance-related products.

As noted above, in certain embodiments, system 100 may include a bundling module 300. Bundling module 300 may be configured to receive historical data. For example, bundling module 300 may be configured to receive information associated with one or more of the user's already purchased insurance-related products, one or more insurance-related products the user previously selected for purchase, one or more previously identified risk factors of the user, one or more previously identified demographics of the user, or other data. In certain embodiments, bundling module 300 may receive historical data from database 150 or user device 170.

As shown in step 302, bundling module 300 may be configured to determine whether the user should be given the option to bundle one or more insurance-related products. Either alternatively or in addition, bundling module 300 may be configured to determine whether collapsible menu 210 should be displayed in user interface 200. In certain embodiments, bundling module 300 may be configured to determine whether the user should be given the option to bundle one or more insurance-related products or whether a collapsible menu should display based on historical data received from database 150 or user device 170. For example, bundling module 300 may determine that the user should or should not be given the option to bundle one or more insurance-related products based, at least in part, on information including, but not limited to, the user's location (e.g., whether bundling is available in the user's location or whether one or more bundling combinations are available in the user's location) or one or more of the user's already purchased insurance-related products or insurance-related products the user previously selected for purchase. In other embodiments, bundling module 300 may be configured to determine whether the user should be given the option to bundle one or more insurance-related products or whether a collapsible menu should display based on supplemental data collected using UCE 350 and user interface 200 (discussed below).

Bundling module 300 may be configured to adjust one or more settings associated with insurance provider system 110 or user device 170. In certain embodiments, bundling module 300 may be configured to adjust one or more settings associated with insurance provider system 110 or user device 170 based on historical data it receives from database 150 or user device 170, supplemental data collected using UCE 350 and user interface 200, or other types of data. In certain embodiments, bundling module 300 may be configured to adjust one or more settings associated with insurance provider system 110 or user device 170 based on one or more of its prior determinations in step 302.

For example, as shown in step 303, bundling module 300 may be configured to enable or disable display settings associated with insurance provider system 110 or user device 170. In certain embodiments, bundling module 300 may be configured to enable or disable display settings associated with insurance provider system 110 or user device 170 based on one or more of its prior determinations in step 302. For example, bundling module 300 may, based its prior determination that collapsible menu 210 should display, enable one or more display settings such that a collapsible menu (e.g., collapsible menu 210) displays on one or more user interfaces (e.g., user interface 200) included in, connected to, or associated with user device 170. As another example, bundling module 300 may, based its prior determination that collapsible menu 210 should not display, disable one or more display settings such that collapsible menu 210 does not display on user interface 200.

As shown in step 304, the user may indicate a desire to edit at least one insurance-related product. For example, the user may select at least one option to edit one or more insurance-related products (e.g., edit option 215 in collapsible menu 210) on user interface 200.

As shown in step 305, in response to the user's indication that he or she wishes to edit at least one insurance-related product, bundling module 300 may identify available or unavailable bundling combinations for insurance-related products. For example, bundling module 300 may identify renter's insurance and automobile insurance as insurance-related products that may be bundled. As another example, bundling module 300 may identify renter's insurance and homeowner's insurance as insurance-related products that may not be bundled. In certain embodiments, bundling module 300 may identify available bundling combinations for insurance-related products based on historical data it receives from database 150 or user device 170, supplemental data collected using UCE 350 and user interface 200, or other types of data. In certain embodiments, bundling module 300 may identify available bundling combinations for insurance-related products based on one or more of its prior determinations at step 302. For example, bundling module 300 may identify available bundling combinations based for insurance-related products based in its prior determination that the user should or should not be given the option to bundle one or more insurance-related products based, at least in part, on the user's location (e.g., whether bundling is available in the user's location or whether one or more bundling combinations are available in the user's location) or one or more of the user's already purchased insurance-related products or insurance-related products the user previously selected for purchase.

As shown in step 306, bundling module 300 may be configured to enable or disable the user's ability to edit (e.g., add, remove, or bundle) insurance-related products. As discussed above with reference to FIGS. 2C and 2D, system 100 may be configured to display, on user interface 200, a plurality of insurance-related products available for purchase from insurance provider 115 in response to the user's selecting edit option 215. Bundling module 300 may be configured to cause system 100 allow or preclude user selection of a subset of the plurality of insurance-related products. In certain embodiments, bundling module 300 may cause system 100 to allow or preclude user selection of a subset of the plurality of insurance-related products based on historical data received from database 150 or user device 170, supplemental data collected using UCE 350 and user interface 200, or other types of data. In certain embodiments, bundling module 300 may cause system 100 to allow or preclude user selection of a subset of the plurality of insurance-related products based on one or more of its prior determinations or identifications at steps 302 or 305, such as its determination that a user should or should not be given the option to bundle one or more insurance-related products or its identification of available or unavailable bundling combinations for insurance-related products. For example, bundling module 300 may cause system 100 to preclude user selection of homeowner's insurance based on (1) the user's prior selection of renter's insurance, and (2) bundling module's prior identification of renter's insurance and homeowner's insurance as insurance-related products that may not be bundled.

In certain embodiments, bundling module 300 may modify one or more of its determinations. For example, bundling module 300 may modify a prior determination that a user should or should not be given the option to bundle one or more insurance-related products or a prior identification of available or unavailable bundling combinations for insurance-related products. In certain embodiments, bundling module 300 may also cause system 100 to update a display of a plurality of insurance-related products available for purchase from insurance provider 115 on user interface 200 in response to bundling module 300's modifying one or more of its prior determinations. For example, if bundling module 300 initially determined that automobile insurance and jewelry insurance policies could not be bundled, yet later determines that that such policies may be bundled, bundling module 300 may cause system 100 may to update a display of a plurality of insurance-related products on user interface 100 to enable simultaneous selection of both automobile insurance and jewelry insurance policies.

In certain embodiments, system 100 may be configured to indicate, on user interface 200, that the subset of the plurality of insurance-related products may or may not be edited by identifying a subset of the plurality of insurance-related products by, for example, highlighting the subset of the plurality of insurance related products in different colors (e.g., greying the subset out if the subset may not be added, removed, or bundled). In other embodiments, system 100 may be configured to display, on user interface 200, only a subset of the plurality of insurance-related products available for purchase from insurance provider 115 based on bundling module 300's determination that only a subset of insurance-related products may be added, removed, or bundled. For example, in response to bundling module 300's disabling of a user's ability to add, remove, or bundle a subset of insurance-related products, system 100 may be configured to not display that subset of insurance-related products on user interface 200.

At step 307, the user may select one or more insurance-related products for purchase. In certain embodiments, the user may select one or more insurance-related products from among the entire plurality of insurance-related products available for purchase from insurance provider 115. In other embodiments, bundling module 300 may have caused system 100 to allow the user to edit only a subset of the plurality of insurance-related products at step 306, and the user may select one or more insurance-related products for purchase from the subset of the plurality of insurance-related products. In certain embodiments, the user may select one or more insurance-related products for purchase via one or more user interfaces (e.g., user interface 200) included in, connected to, or associated with user device 170.

As shown in step 308, in response to the user's selection of one or more insurance-related products for purchase, bundling module 300 may identify available or unavailable bundling combinations for insurance-related products. In certain embodiments, bundling module 300 may replace or overwrite its previous identifications from step 305. In other embodiments, bundling module 300 may modify its previous identifications from step 305. Bundling module 300 may conduct these identification processes in a manner similar or identical to the processes set forth in step 305 above, or base its identification(s) on data and/or prior determination(s) factored into its identification(s) in step 305.

As shown in step 309, bundling module 300 may cause system 100 to update a display of a plurality of insurance-related products available for purchase from insurance provider 115 on a user interface (e.g., user interface 200) in response to the user's selection of one or more insurance-related products at step 307. For example, bundling module 300 may cause system 100 to reactively enable or disable the user's ability to edit (e.g., add, remove, or bundle) insurance-related products in response to the user's selection of one or more insurance-related products at step 307. Bundling module 300 may cause system 100 to update a display of a plurality of insurance-related products available for purchase or enable or disable the user's ability to edit the user's insurance-related products via processes similar or identical to the processes set forth in step 306. In certain embodiments, bundling module 300 may cause system 100 to allow or preclude user selection of a subset of the plurality of insurance-related products based on historical data received from database 150 or user device 170, supplemental data collected using UCE 350 and user interface 200, or other types of data. In certain embodiments, bundling module 300 may cause system 100 to allow or preclude user selection of a subset of the plurality of insurance-related products based on one or more of its prior determinations or identifications at steps 302 or 308.

At step 310, the user may submit one or more insurance-related products for purchase. For example, the user may submit the one or more insurance-related products he or she previously selected for purchase at step 307 above. In certain embodiments, the user may submit one or more insurance-related products for purchase to system 100 by selecting an option on user interface 200.

At step 311, bundling module 300 may analyze data it has collected or generated and map said data to one or more product questionnaires. In certain embodiments, bundling module 300 may analyze data it has collected or generated at one or more of steps 301 to 310 above and map said data to one or more product questionnaires. In certain embodiments, bundling module 300 may analyze historical data it receives from database 150 or user device 170, supplemental data collected using UCE 350 and user interface 200, or other types of data and map said data to one or more product questionnaires. Bundling module 300 may, based on its analysis of certain data it has collected or generated, identify relevant product questionnaires for mapping purposes. For example, bundling module 300 may, based on the user's selection and/or submission of jewelry insurance at steps 307 and/or 310, identify a jewelry insurance product questionnaire and map other data that it has collected or generated onto questions within said questionnaire.

At step 312, bundling module 300 may determine that it needs additional data from the user before it can fully customize one or more insurance-related products or calculate a price quote for one or more customized insurance products. As a result, bundling module 300 may call a universal conversation engine (“UCE”) 350. In certain embodiments, UCE 350 may be embedded, integrated, or otherwise included in bundling module 300. In other embodiments, UCE 350 may be another component of system 100 or external to system 100 and may be connected to or associated with bundling module 300. UCE 350 may be configured to dynamically generate or communicate one or more product questionnaires to the user, wherein each questionnaire comprises one or more questions designed to collect supplemental data from the user. UCE 350 may be further configured to collect said supplemental data from the user and convey the supplemental data to bundling module 300. In certain embodiments, the questions may be designed to collect supplemental data to customize one or more insurance-related products for the user. In certain embodiments, the questions may be designed to collect supplemental data that will inform a subsequent determination by bundling module 300 (e.g., the calculation of a price quote for one or more customized insurance products). In certain embodiments, the questions may be designed to collect supplemental data (e.g., the value of an item of jewelry) that will inform a subsequent determination by bundling module 300 with respect to a single insurance-related product (e.g., a jewelry insurance policy). In other embodiments, the questions may be designed to collect supplemental data (e.g., a credit score) that will inform a subsequent determination by bundling module 300 with respect to multiple insurance-related products (e.g., automobile and homeowner's insurance policies). Supplemental data may include, for example, one or more risk factors of or associated with the user, one or more demographics of or associated with the user, or other information about the user.

In certain embodiments, UCE 350 may cause system 100 to display one or more questions on one or more user interfaces (e.g., user interface 200) associated with user device 170. UCE 350 may also cause system 100 to display one or more areas in which a user may input one or more responses to one or more questions in one or more locations on user interface 200. For example, UCE 350 may cause system 100 to display one or more text boxes, drop-down menus, lists having radio buttons or checkboxes, or other areas permitting the user to input one or more responses to one or more questions. UCE 350 may receive input from the user via user interface 200.

UCE 350 may be configured to configured to automatically determine that a question within a product questionnaire should or should not be presented to the user based on historical data it receives from database 150 or user device 170, supplemental data collected using UCE 350 and user interface 200, or other types of data. For example, UCE 350 may determine that a question requesting the user's address in a homeowner's insurance policy questionnaire is unnecessary based on the user's prior provision of his or her address, which was previously stored in database 150, and therefore should not be presented to the user. As another example, UCE 350 may be configured to automatically determine that a subsequent question should or should not be presented to the user based on supplemental data, such an input UCE 350 collected from the user in response to a prior question. In certain embodiments, UCE 350 may be configured to determine that a subsequent question in a questionnaire should or should not be presented to the user based on a response from the user to a prior question in the same questionnaire. In certain embodiments, UCE 350 may be configured to determine that a subsequent question in a questionnaire should or should not be presented to the user based on a response from the user to a prior question in a different questionnaire. For example, UCE 350 may be configured to present a question requesting a suite number from the user based on the user's prior indication, in response to a previous question, that the user lives in an apartment complex.

In certain embodiments, bundling module 300 may be configured to update historical data stored in database 150 or other portions of insurance provider system 110 based on all or a portion of the supplemental data collected by UCE 350.

At step 313, bundling module 300 may, based on the data previously generated or collected at one or more of steps 301 through 312, determine whether it needs additional data from the user before it can fully customize one or more insurance-related products or calculate a price quote for one or more customized insurance products. In certain embodiments, bundling module 300 may determine that it indeed needs additional data from the user before it can fully customize one or more insurance related products or calculate a price quote for one or more customized insurance products. Bundling module 300 may then call UCE 350 to generate, present, and collect data provided in response to additional product questionnaires via processes similar or identical to those presented at step 312 above. In other embodiments, bundling module 300 may determine that it has sufficient data from the user to calculate a price quote.

At step 314, bundling module 300 may analyze data it has collected or generated and map said data to one or more product questionnaires. In certain embodiments, bundling module 300 may analyze data it has collected or generated at one or more of steps 301 to 313 above and map said data to one or more product questionnaires. These analysis and mapping processes may proceed in a manner similar or identical to the processes set forth at step 311. In certain embodiments, bundling module 300 may use the analyzed and mapped data to customize ore personalize one or more insurance-related products selected for purchase by the user to generate one or more customized insurance products. In certain embodiments, bundling module 300 may reserve the analyzed and mapped data for use in calculating a price quote for one or more of the user's already purchased insurance-related products, insurance-related products the user has selected for purchase, or customized insurance products.

At step 315, bundling module 300 may call UCE 350 to calculate a price quote for one or more of the user's already purchased insurance-related products, insurance-related products the user has selected for purchase, or customized insurance products. In certain embodiments, UCE 350 may be configured to calculate a price quote based, at least in part, on historical data it receives from database 150 or user device 170, supplemental data collected using UCE 350 and user interface 200, or other types of data. In certain embodiments, UCE 350 may be configured to calculate a price quote based, at least in part, on supplemental data collected from one or more product questionnaires at steps 312 or 313. For example, UCE 350 may be configured to calculate a price quote for a jewelry insurance policy based in part on supplemental data regarding the types of jewelry to be insured and/or the value of said jewelry. In certain embodiments, UCE 350 may be configured to calculate a price quote in view of data that has been mapped to one or more product questionnaires by bundling module 300 at steps 311 or 314. UCE 350 may convey the calculated price quote to bundling module 300.

At step 316, bundling module 300 may compile a quote display including the price quote for one or more of the user's already purchased insurance-related products, insurance-related products the user has selected for purchase, or customized insurance products calculated by UCE 350. In certain embodiments, bundling module 300 may include only the price quote in the newly compiled display. In other embodiments, bundling module 300 may include additional information about, for example, the price quote; the user; one or more of the user's already purchased insurance-related products, insurance-related products the user has selected for purchase, or customized insurance products; or one or more other insurance-related products that the user has not selected for purchase in the newly compiled display. For example, bundling module 300 may include an itemized list of customized insurance products that UCE 350 factored into the price quote.

At step 317, bundling module 300 may cause system 100 to display the newly compiled quote display to the user. In certain embodiments, bundling module 300 may cause system 100 to display the newly compiled quote display via one or more user interfaces (e.g., user interface 200) associated with user device 170. In certain embodiments, bundling module 300 may cause system 100 to prompt the user, via user interface 200, to indicate that he or she wishes to see the newly compiled quote display prior to causing system 100 to display the newly compiled quote display to the user. The user may indicate that he or she wishes to see the newly compiled quote display via user interface 200. For example, bundling module 300 may cause system 100 to display a selectable option to “See My Quote” on user interface 200, and only cause system 100 to display the newly compiled quote display to the user on user interface 200 upon the user's selection of the selectable option.

Upon viewing the newly compiled quote display presented at step 317, a user may wish to select and/or deselect one or more insurance-related products for purchase. The processes by which this selection and/or deselection may be accomplished, and a new price quote calculated, are set forth in steps 318 through 329, shown in FIGS. 3E-3G. Each of these steps may be accomplished via processes similar or identical to one or more of steps 301 to 317 above. In certain embodiments, each of these steps may be accomplished via processes similar or identical to one or more of steps 304 to 317 above. Bundling module 300 and UCE 350 may be configured to repeat any of the processes set forth in the preceding paragraphs as many times as is necessary to generate a satisfactory insurance quote for a user.

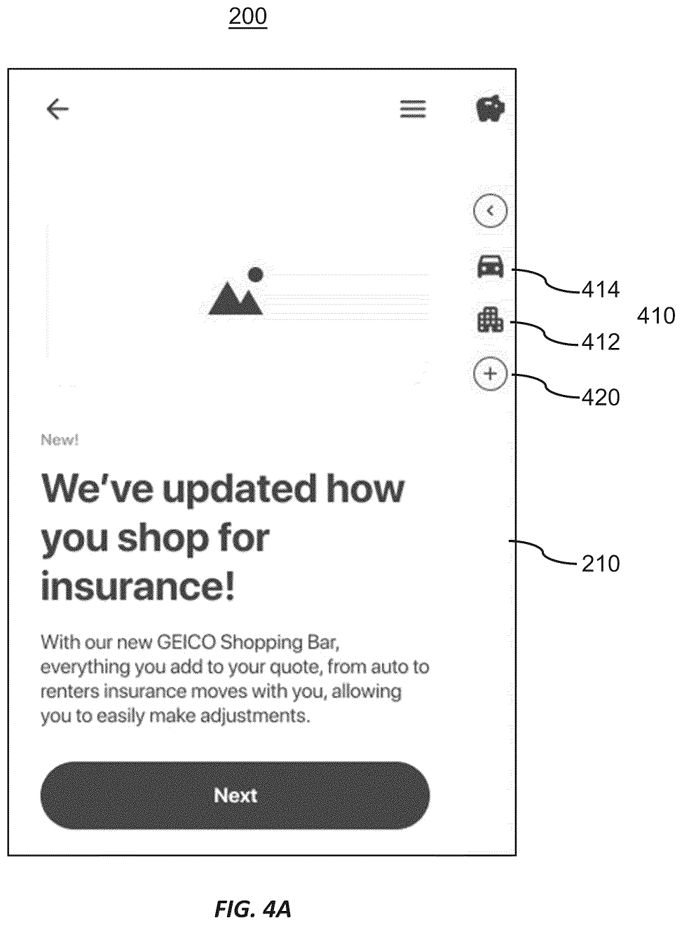

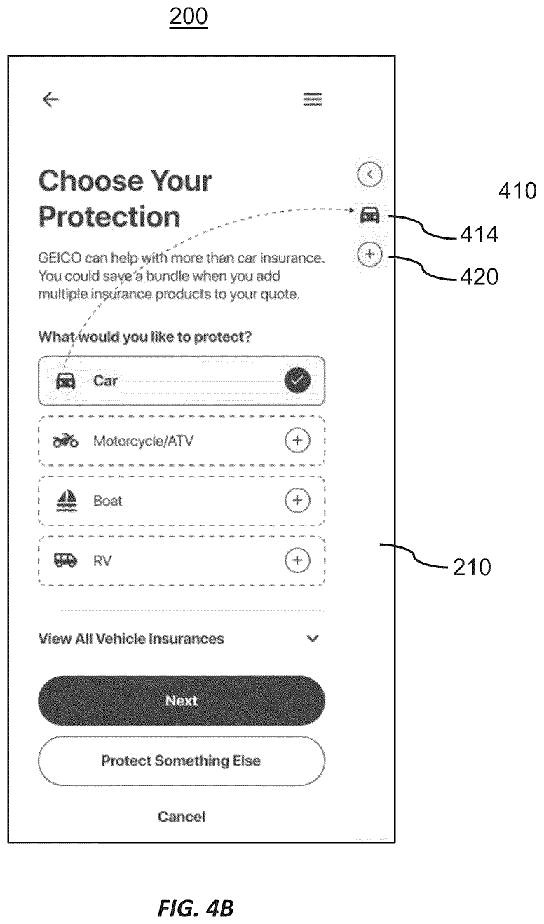

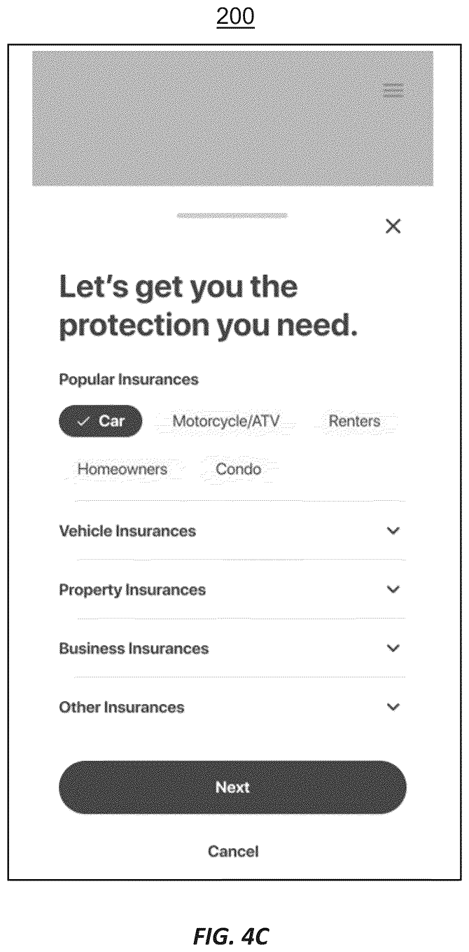

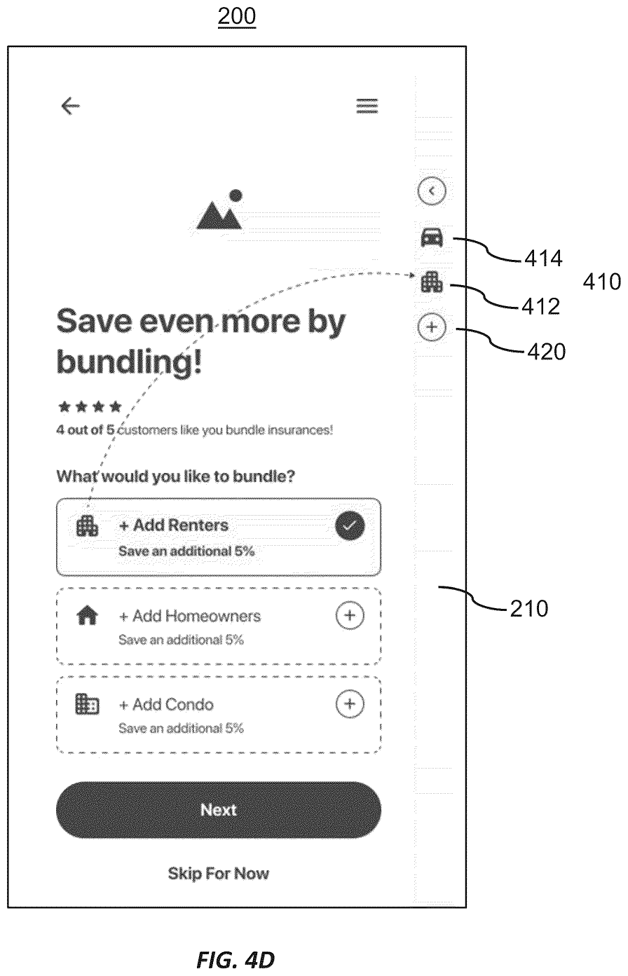

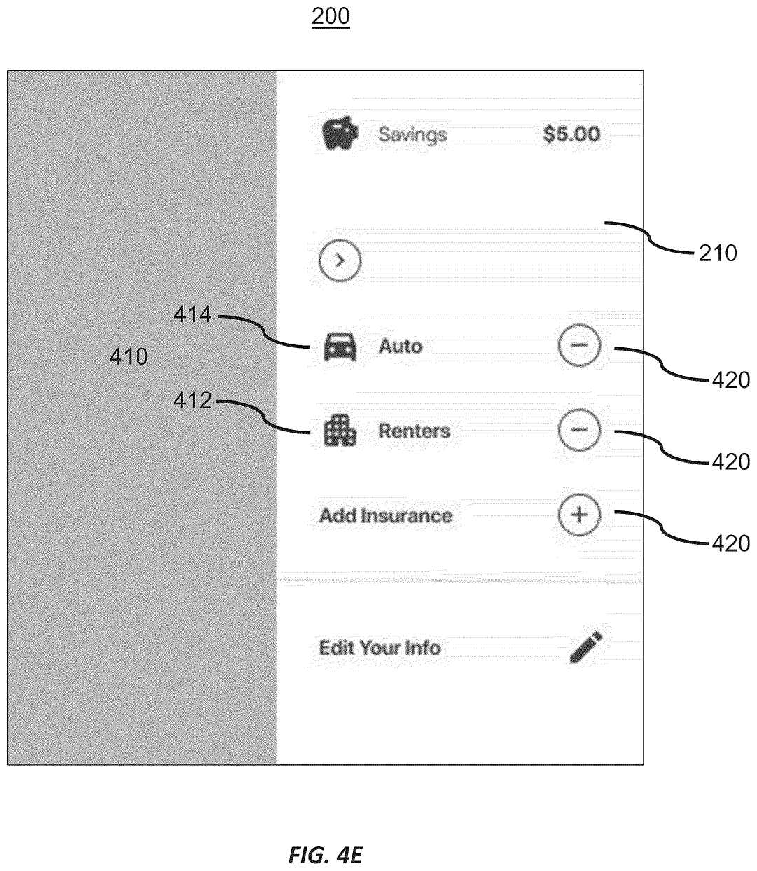

FIG. 4 illustrates a user interface displaying a user's insurance information and a collapsible sidebar.

In certain embodiments, system 100 may be configured to display a collapsible menu 210 on user interface 200. In certain embodiments, system 100 may be configured to display collapsible menu 200 continuously, regardless of any option selected, action taken, or information provided by the user. In other embodiments, system 100 may be configured to display collapsible menu 210 intermittently and/or based on one or more settings enabled or disabled by bundling module 300 included in system 100.

Collapsible menu 210 may comprise a bar, block, or any other shape. In a preferred embodiment, shown in FIGS. 4A, 4B, and 4D, collapsible menu 210 comprises a bar. In certain embodiments, collapsible menu 210 may be pinned to one or more edges of or other locations on user interface 200. In a preferred embodiment, collapsible menu 210 is pinned to the right side of user interface 200.

Collapsible menu 210 may include one or more product indicators 410 representing one or more insurance-related products. In certain embodiments, product indicators 410 may include at least one of an icon, a photograph, or another graphic. For example, product indicators 410 may comprise a ring icon, which may represent jewelry insurance. As another example, product indicators 410 may comprise a house icon, which may represent homeowner's insurance. In certain embodiments, product indicators 410 may include text. In certain embodiments, collapsible menu 210 may display one or more product indicators based on a user's selection of one or more insurance-related products for purchase.

As shown in FIGS. 4B and 4D, system 100 may be configured to update the collapsible menu by adding or removing at least one product indicator 410 representing the selected at least one insurance-related product within the collapsible menu. In certain embodiments, system 200 may be configured to update the collapsible menu in response to a user's selection or deselection of one or more insurance-related products for purchase.

As shown in FIGS. 4A, 4B, 4D, and 4E, collapsible menu 210 may include at least one edit indicator 420 representing at least one option to add, remove, or otherwise edit insurance-related products. In certain embodiments, edit indicator 420 may include at least one of an icon, a photograph, or another graphic. In certain embodiments, edit indicator 420 may include text.

System 100 may be configured to expand or collapse collapsible menu 210 in response to one or more actions taken by a user through user interface 100. For example, system 100 may expand collapsible menu 210 in response to the user clicking on collapsible menu 210 using a computer mouse, stylus, pointer, user's finger, or any other means. As another example, system 100 may expand collapsible menu 210 in response to a user hovering a pointer over the collapsible menu for an extended period of time. A pointer may include a cursor, arrow, or any other means used to indicate a position on a user interface. As another example, system 100 may collapse collapsible menu 210 in response to the user clicking on a particular area within collapsible menu 210 or on a portion of user interface 200 outside of collapsible menu 210. As another example, system 100 may collapse collapsible menu 210 in response to the user hovering a pointer over a particular area within collapsible menu 210 or on a portion of user interface 200 outside of collapsible menu 210.

As shown in FIG. 4E, collapsible menu 210 may comprise an expanded form and a collapsed form. In certain embodiments, the expanded form may display expanded form product indicators and/or an expanded form edit indicator, and the collapsed form may display collapsed form product indicators and/or a collapsed form edit indicator. In certain embodiments, the expanded form product indicators and narrow form product indicators may be identical; in other embodiments, the expanded form product indicators may be different from the narrow form product indicators. In certain embodiments, the expanded form edit indicator and narrow form edit indicator may be identical; in other embodiments, the expanded form edit indicator may be different from the narrow form edit indicator.

In certain embodiments, system 100 may be configured to receive from a user a selection of at least one option to add, remove, or otherwise edit insurance-related products for purchase through collapsible menu 210. In certain embodiments, a user may click on or otherwise select edit indicator 420 in the collapsible menu to indicate that the user wishes to add, remove, or otherwise edit insurance-related products for purchase.

Collapsible menu 110 may display one or more product indicators 410 based on historical data from database 150, user device 170, and/or bundling module 300 included in system 100. In certain embodiments, product indicators 410 may comprise a first product indicator 412 and a second product indicator 414. In certain embodiments, first product indicator 412 and/or second product indicator 414 may be displayed based on historical data from database 150 or user device 170. In certain embodiments first product indicator and/or second product indicator 414 may be displayed based on supplemental data collected from a user through a universal conversation engine (e.g., UCE 350) and user interface 200.

Historical data may be data that is collected on a user. In certain embodiments, historical data may include insurance-related products a user has previously purchased or selected for purchase. System 100 may analyze this historical data to determine potential product indicators to display to a user. For example, collapsible menu 210 may display one or more product indicators based on the user's already purchased insurance-related products and/or insurance-related products the user previously selected for purchase. For example, a user may have bought renter's insurance in the past or previously selected renter's insurance for purchase, and system 100 may cause collapsible menu 210 to display a house icon to a user in product indicators 410.

In certain embodiments, collapsible menu 210 may be configured to display one or more product indicators 410 based on supplemental data received through user input in response to questions posited by the universal conversation engine (e.g., UCE 350) through user interface 200. For example, system 100 may update collapsible menu 210 to display a one or more product indicators based on a user's new selection of one or more insurance-related products for purchase, or may update collapsible menu 210 to remove from display one or more product indicators based on a user's new deselection of one or more insurance-related products for purchase.

In certain embodiments, collapsible menu may display a first product indicator 412 for a first insurance-related product the user has selected for purchase and a second product indicator 414 for a second insurance-related product that the user has already purchased or has previously selected for purchase. The second insurance-related product may be identified by system 100 using historical data. For example, a user may select renter's insurance as a first insurance-related product for purchase. System 100 may further identify motorcycle insurance as having previously been selected by the user based on historical data, including the user's history of owning a motorcycle. System 100 may consequently update collapsible menu 210 to include a house icon to represent renter's insurance and a motorcycle icon to represent motorcycle insurance.

In certain embodiments, system 100, through UCE 350 included in or associated with bundling module 300, may generate a questionnaire for customizing insurance service products based on at least one insurance-related product that was either previously purchased or selected for purchase by the user. A questionnaire may include a set of questions directed to the user. UCE 350 may generate the questionnaire based on a user selected insurance-related product. For example, a user may select renter's insurance, and UCE 350 may generate a questionnaire including questions related to the cost of a user's rent, the size of the rental unit, the length of the user's lease, or other questions related to the rental unit or lease. The questionnaire may be used to modify a user's insurance product and customize it according to the user's particular needs.

In certain embodiments, system 100 may provide the questionnaire on a user interface (e.g., user interface 200) included in, connected to, or associated with user device 170. For example, the questionnaire may be presented to a user on a mobile device, computer, tablet, web browser, or other types of interfaces.

In certain embodiments, system 100 may receive a user input in response to the questionnaire. The user may provide an input in response to one or more of the questions of the questionnaire through user interface 200 using one or more input formats. For example, the user may provide an input in response to one or more of the questions through a free-form text box. As another example, the user may provide an input in response to one or more of the questions using a drop-down menu. As another example, a questionnaire may include multiple answer choices, and a user may select one or more specific choices in response to one or more of the questions. For example, a user may select jewelry insurance. The questionnaire may include a question asking what type of jewelry a user wants to insure. A user may enter “watch” into a text box in response to the question. As another example, the questionnaire may include a question asking how much a user's jewelry costs and may provide a list of options including “under $1,000,” “between $1,000 and $5,000,” “greater than $5,000” in a drop-down menu. A user may then select one of the options in the drop-down menu to respond to the question.

In certain embodiments, system 100 generates a custom insurance product is based, at least in part, on the user input it receives in response to the questionnaire prepared by the universal conversation engine (e.g., UCE 350). For example, a custom insurance product may be created based on the user's response to certain questions within the questionnaire. For example, a user may respond that a piece of jewelry is “between $1,000 and $5,000.” In response, system 100 may suggest to a user an insurance policy costing $50 per year.

In certain embodiments, the questionnaire may request information associated with at least one user insurance risk factor associated with the user. A user insurance risk factor may include a variable that is associated with an increased chance of loss or damage to a valuable asset being insured. For example, a user may have a car accident history that includes an accident where the user hit a parked car. This history may indicate that the user has a history of hitting parked cars. Therefore, a user's history of damage to a valuable asset is high. Other user insurance risk factors may include one or more demographics of the user, a location of the user, a residence of the user, a vehicle of the user, a credit history of the user, an accident report of the user, a police record of the user, an insurance history report of the user, a record or report on a vehicle associated with the user, or a record or report on a residence associated with the user.

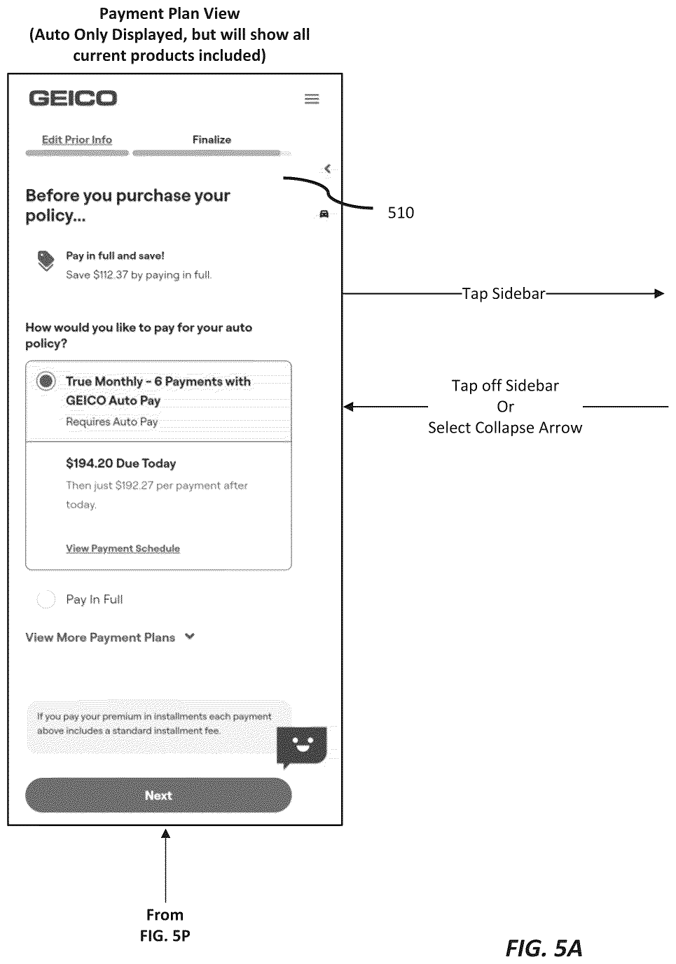

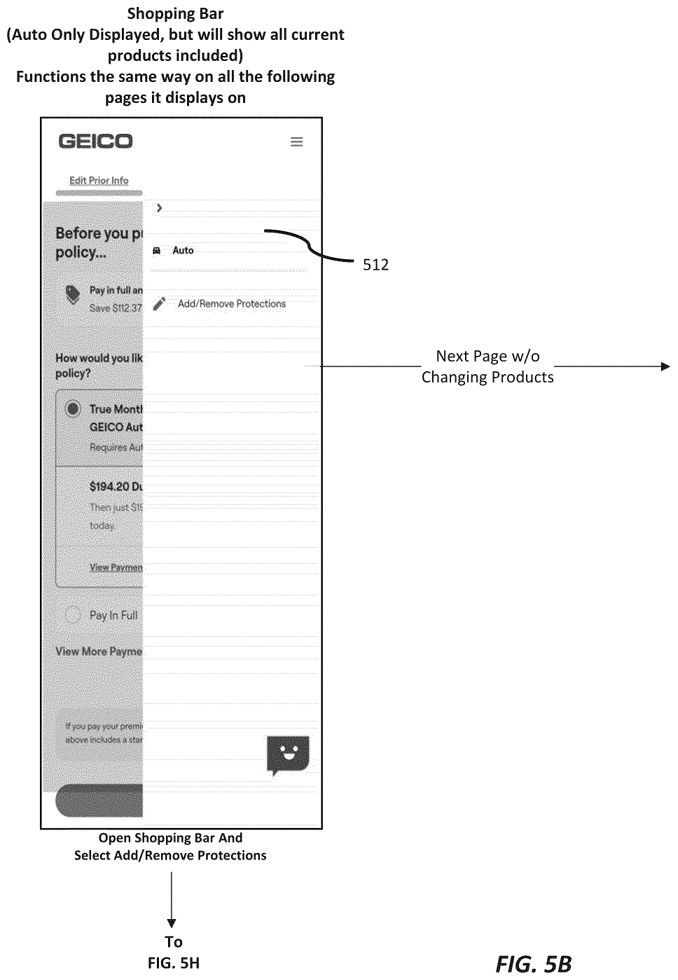

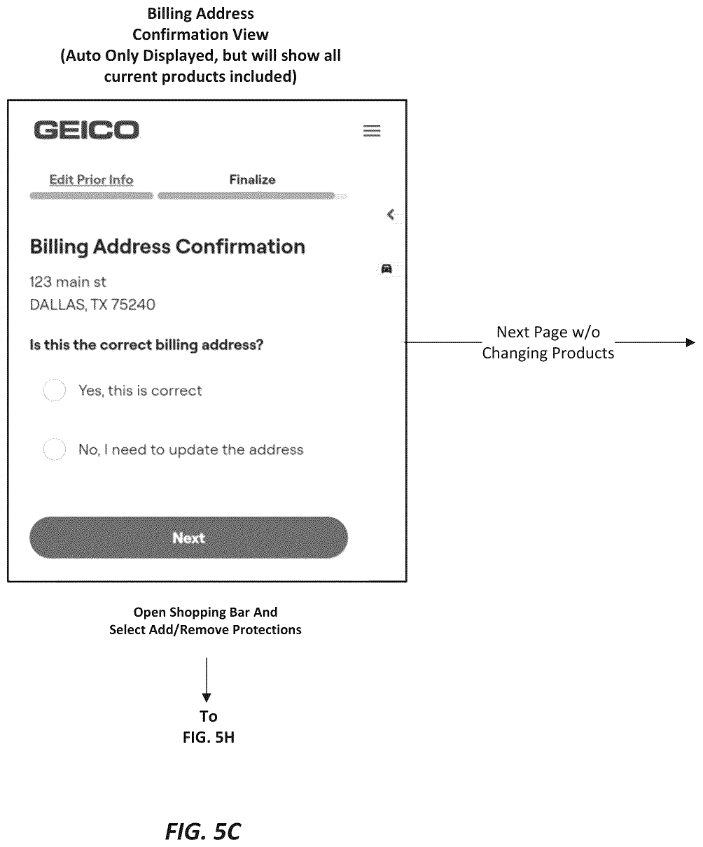

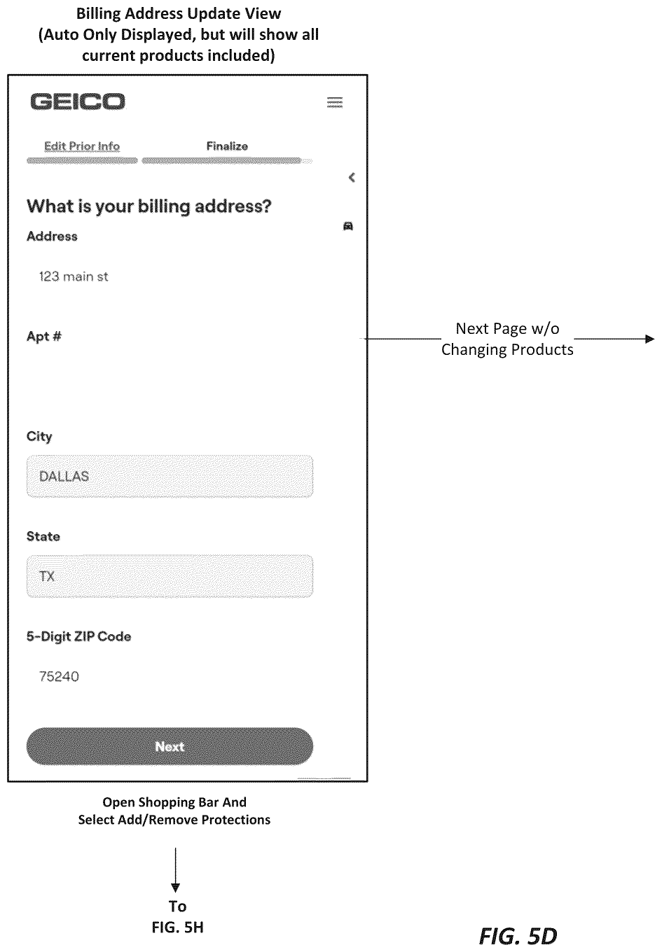

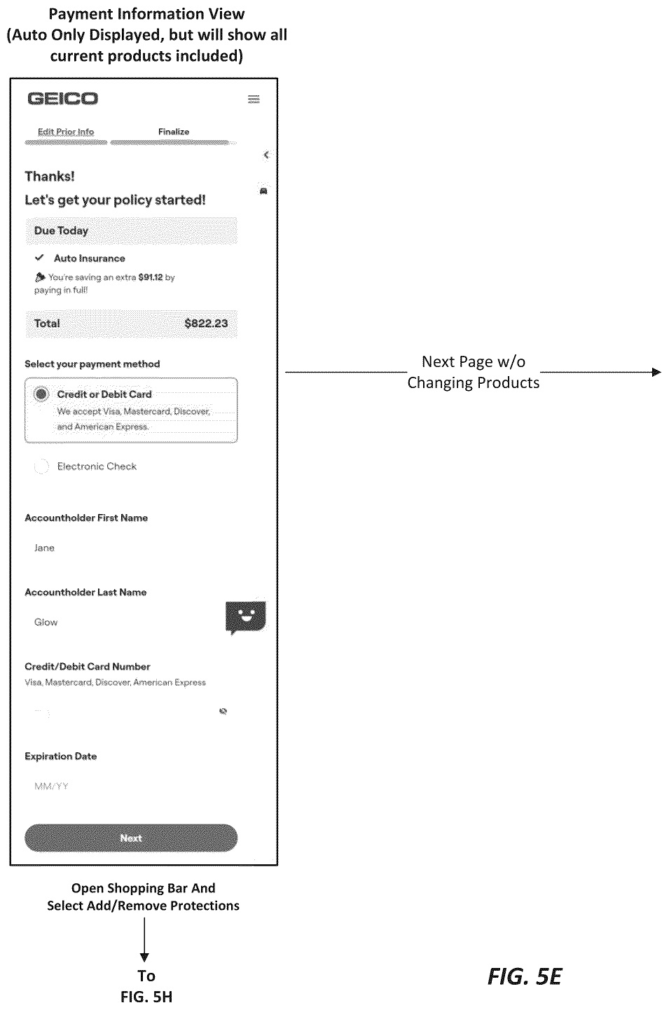

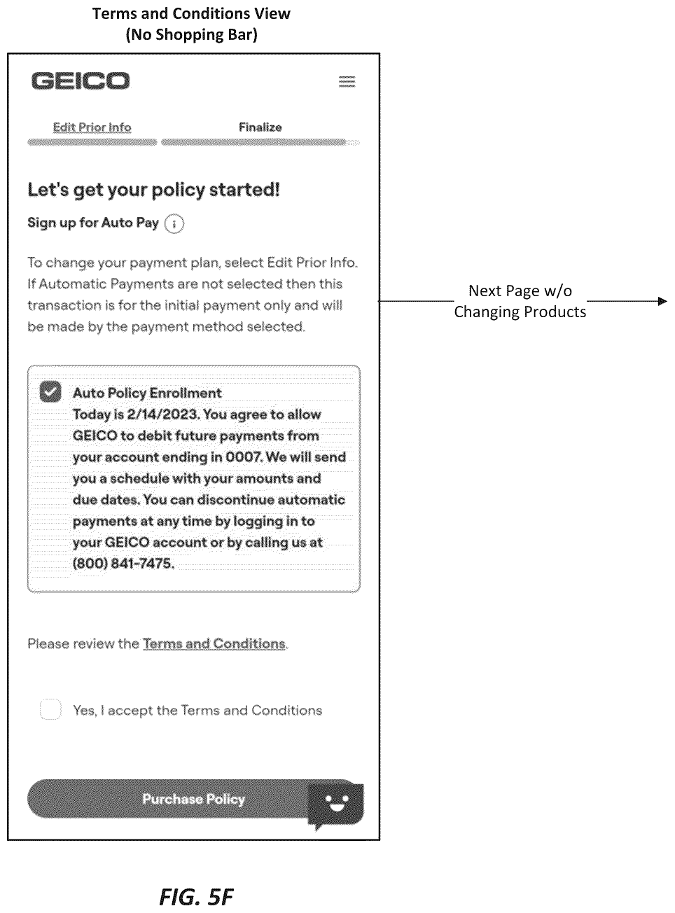

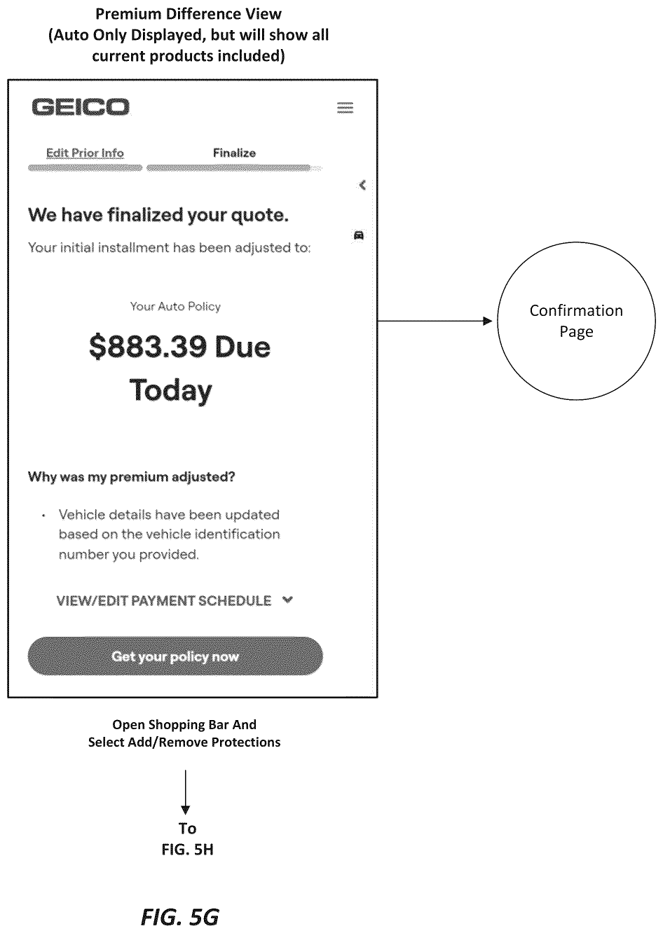

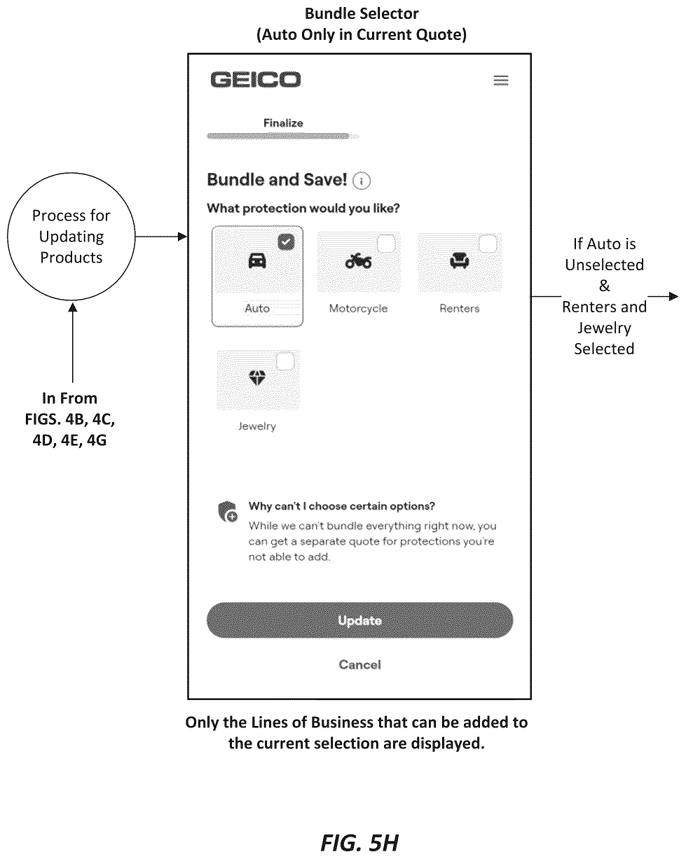

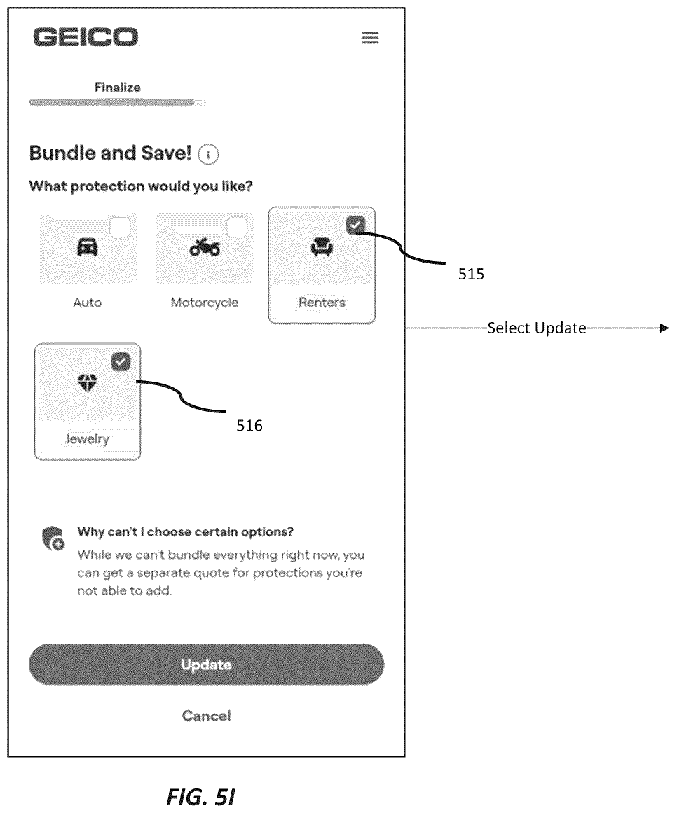

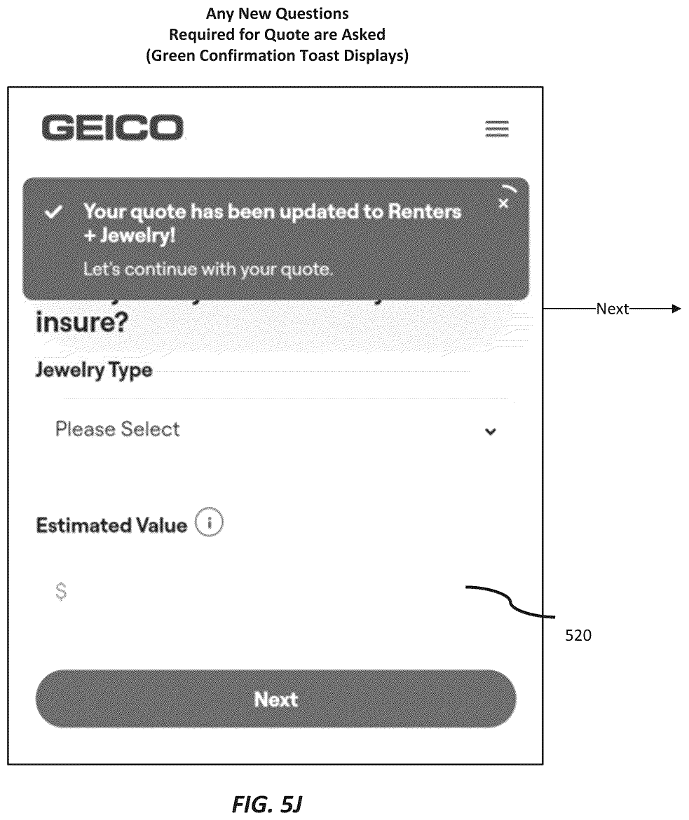

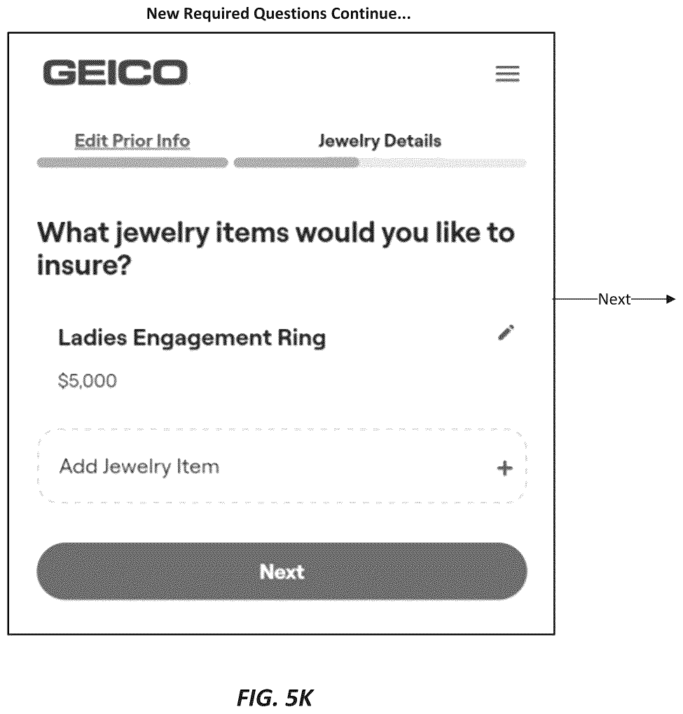

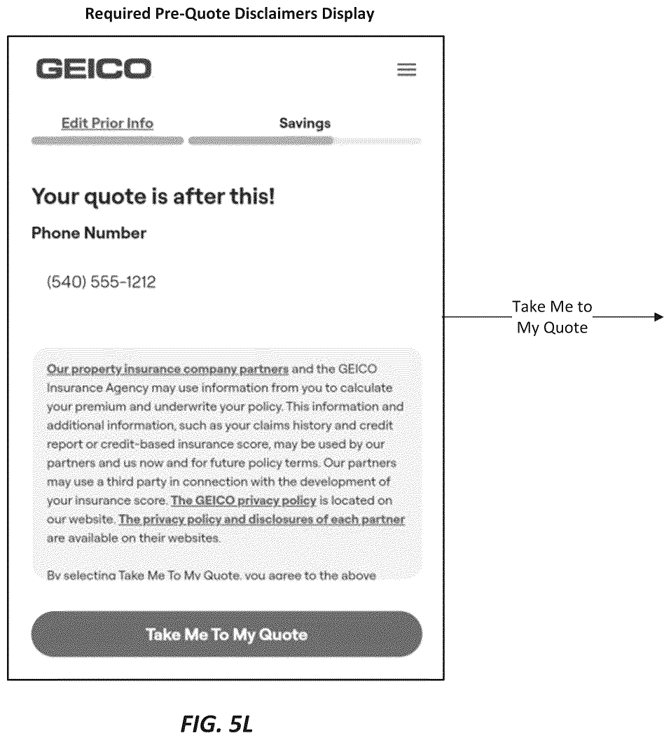

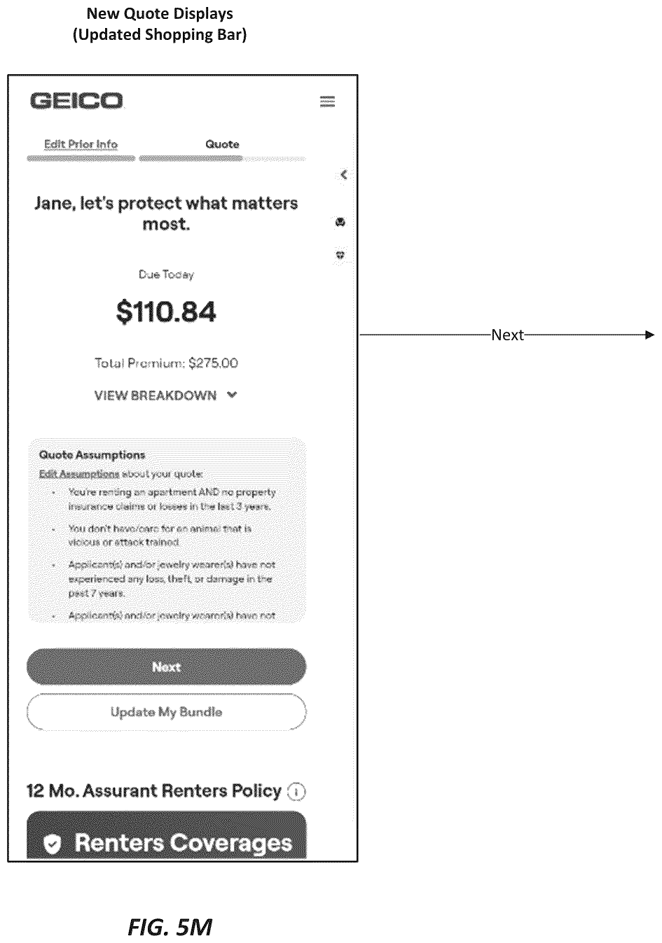

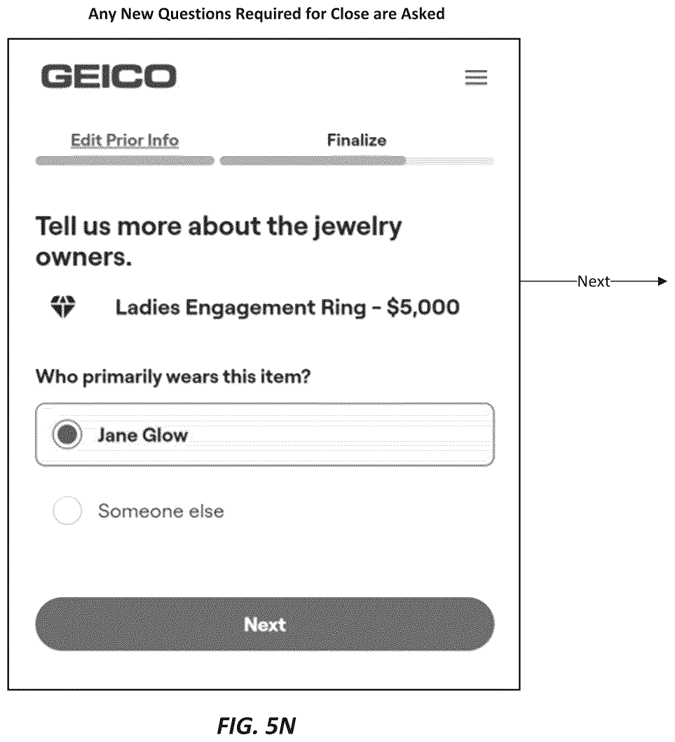

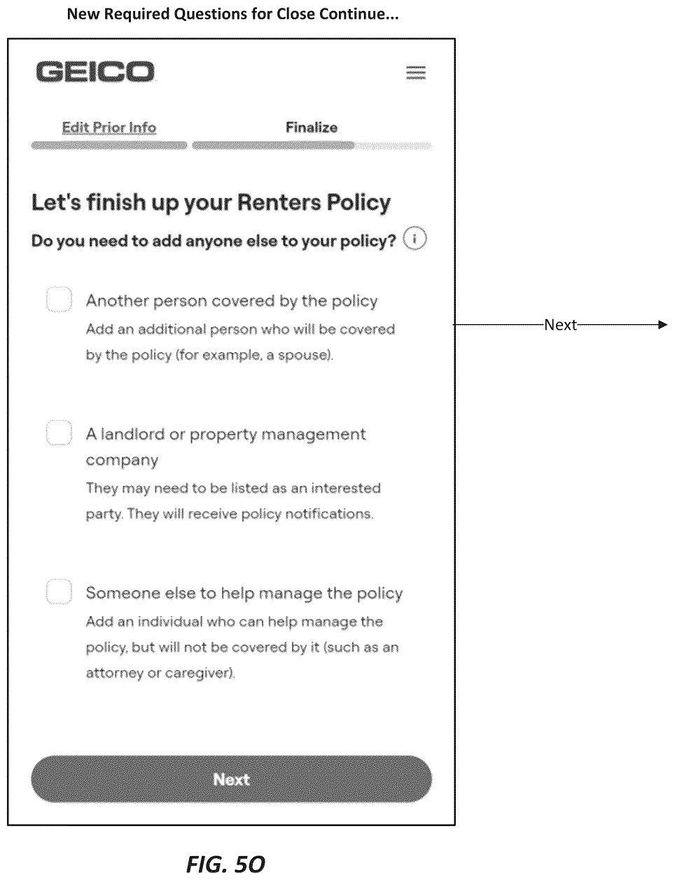

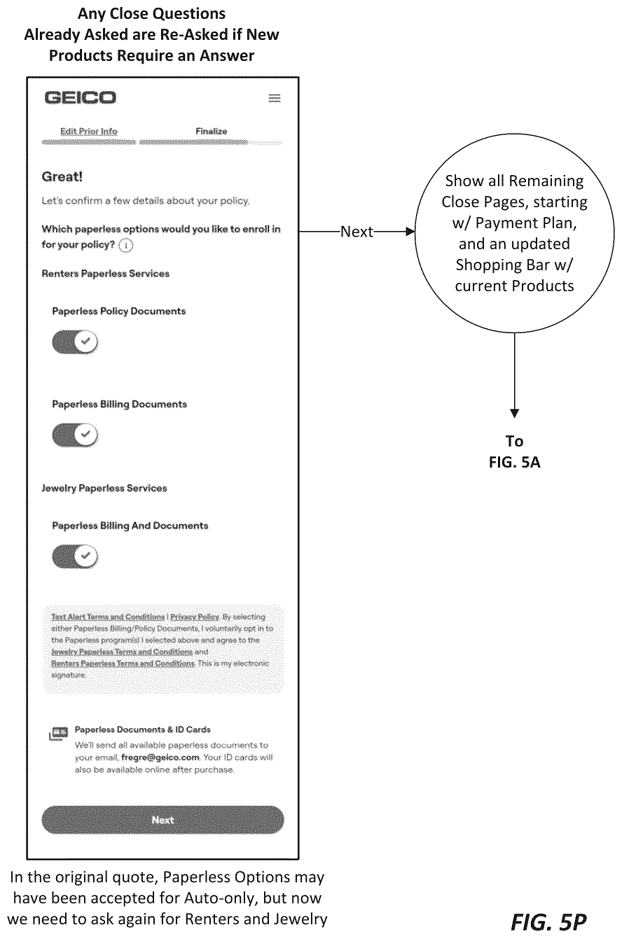

As shown in FIGS. 5A-5P, a system may provide an insurance payment plan to a user and/or arranges a user's purchase of one or more customized insurance products. For example, as shown in FIG. 5A, the user may be presented with an option to create an insurance payment plan for one or more customized insurance products. The user may be presented with the option to create an insurance payment plan, for example, after the user provides one or more inputs in response to a questionnaire generated by the universal conversation engine (e.g., UCE 350) or after a price quote for one or more insurance-related products or customized insurance products calculated by the bundling module (e.g., bundling module 300) is displayed on one or more user interfaces (e.g., user interface 510) associated with the user device. The user interface 510 may prompt a user to provide an input indicating whether the user wishes to pay for the customized insurance product(s) in installments at various rates or to pay for the customized insurance product(s) all at once. As shown in FIG. 5B, the user may use the collapsible sidebar 512 to change insurance-related products or to add or remove insurance-related products. As shown in FIGS. 5C-5F, the user may be prompted to input or confirm information about the user, such as the user's billing address or payment information or whether the user wishes to enroll in an automatic payment structure. Upon collecting this additional information and/or determining that the user has completed all necessary steps to purchase an insurance policy, system 100 may, on the user interface, present an indication that the user has completed all necessary steps to purchase an insurance policy, present a final quote for the user's customized insurance product(s), and/or ask the user to confirm that he or she wishes to proceed with purchasing the policy, as shown in Figure G.

System 100 may afford a user an opportunity to add, modify, or remove insurance-related products as system 100 prepares to provide an insurance payment plan to the user and/or arranges the user's purchase of one or more customized insurance products. Should the user wish to add, modify, or remove insurance-related products, system 100 may call upon any of the processes and/or functionalities previously described to allow the user to update the user's price quote and/or purchase.

For example, a user may wish to adjust the insurance-related products that the user has selected and thus select an edit option (e.g., edit option 215) in a collapsible sidebar (e.g., collapsible sidebar 210) displayed in a user interface (e.g., user interface 200). Based on the user's selection of the edit option, system 100 may display, in the user interface, a plurality of insurance-related products, as shown in FIG. 5H. One or more of the insurance-related products in the plurality of insurance-related products may be identified as having been previously selected by the user. A subset of the plurality of insurance-related products may be identified as selectable by the user. As shown in FIGS. 5H and SI, the user may, using this interface, deselect and/or select one or more insurance-related products in the plurality of insurance-related products. For example, a user may, via the user interface, deselect automobile insurance (514) and select both renter's insurance (515) and jewelry insurance (516). In response to the user's selections and/or deselections, system 100 may, through a bundling module (e.g., bundling module 300), determine that additional information is required to calculate a price quote for the user's selected insurance-related products. System 100 may thus cause a universal conversation engine (e.g., UCE 350) to present one or more questions to the user and prompt the user to provide input in response, as shown in FIGS. 5J-5K. For example, if the user newly selected jewelry insurance, UCE 350 may present questions to the user, the answers to which could influence the calculation a price quote for the user's jewelry insurance. For example, the user may be asked a question about the estimated value of a piece of jewelry and may be prompted to enter the estimated value in, for example, a text box (e.g., text box 520). As another example, the user may be asked a question about which items of jewelry the user wishes to insure and may be prompted to select all applicable items of jewelry.

As shown in FIGS. 5L and 5M, system 100 may, via the user interface, prompt a user to select an option to receive a final price quote for the user's newly selected insurance-related products and/or customized insurance products and/or display the final price quote for the user's newly selected insurance-related products and/or customized insurance products. System 100 may prompt the user to select the option to receive the final price quote and/or display the final price quote after receiving the user's input in response to the questionnaire(s) presented by the universal conversation engine (e.g., UCE 350). Once the final price quote has been displayed, as shown in FIGS. 5N-5P, system 100 may, via the user interface, prompt a user to respond to additional questions so that system 100 can finalize the user's purchase of the insurance-related products and/or customized insurance products. For example, if the user is purchasing jewelry and renter's insurance, system 100 may prompt the user to provide an input in response to questions about the owner of an item of jewelry being insured or whether other policyholders should be identified on the renter's insurance policy. As another example, system 100 may prompt the user to respond to questions about how the user would like to receive the user's billing statements (e.g., via mail, electronically). These additional questions may be generated by UCE 350 included in system 100.

1. A system comprising:
one or more memory devices storing instructions; and
one or more processors configured to execute the instructions to:
display on a user interface a collapsible menu, wherein the collapsible menu includes at least one option to add or remove insurance-related products;
receive from a user a selection of the at least one option to add or remove insurance-related products;
provide on the user interface a plurality of insurance-related products based on the selection of the at least one option to add or remove insurance-related products;
receive from the user a selection of at least one insurance-related product in the plurality of insurance-related products to add or remove;
update the collapsible menu based on the selected at least one insurance-related product;
determine a custom insurance service product for the user based on the selected at least one insurance-related product; and
provide on the user interface information on the custom insurance service product.

2. The system of claim 1, wherein the collapsible menu expands in response to at least one of a user clicking on the collapsible menu or a pointer hovering over the collapsible menu.

3. The system of claim 1, wherein updating the collapsible menu comprises adding or removing at least one indicator representing the selected at least one insurance-related product within the collapsible menu.

4. The system of claim 3, wherein the at least one indicator comprises an icon.

5. The system of claim 3, wherein the at least one indicator comprises a first indicator, and the collapsible menu further displays a second indicator based on historical data of the user.

6. The system of claim 5, wherein the selected at least one insurance-related product comprises a first insurance-related product, and the historical data of the user comprises a second insurance-related product selected by the user.

7. The system of claim 1, wherein, upon receiving from the user the selection of the at least one insurance-related product in the plurality of insurance-related products, the one or more processors are further configured to execute the instructions to:
generate a questionnaire for customizing insurance service products based on the selected at least one insurance-related product;
provide the questionnaire on the user interface; and
receive a user input in response to the questionnaire.

8. The system of claim 7, wherein the questionnaire requests information associated with at least one user insurance risk factor.

9. The system of claim 8, wherein the user insurance risk factor is associated with at least one of a demographic of the user, a location of the user, a residence of the user, a vehicle of the user, a credit history of the user, an accident report of the user, a police record of the user, an insurance history report of the user, a record or report on a vehicle associated with the user, or a record or report on a residence associated with the user.

10. The system of claim 7, wherein determining the custom insurance product is further based on the received user input.

11. A method comprising:
display on a user interface a collapsible menu, wherein the collapsible menu includes at least one option to add or remove insurance-related products;
receiving from a user a selection of the at least one option to add or remove insurance-related products;
providing on the user interface a plurality of insurance-related products based on the selection of the at least one option to add or remove insurance-related products;
receiving from the user a selection of at least one insurance-related product in the plurality of insurance-related products to add or remove;
updating the collapsible menu based on the selected at least one insurance-related product;
determining a custom insurance service product for the user based on the selected at least one insurance-related product; and
providing on the user interface information on the custom insurance service product.

12. The method of claim 11, wherein the collapsible menu expands in response to at least one of a user clicking on the collapsible menu or a pointer hovering over the collapsible menu.

13. The method of claim 11, wherein updating the collapsible menu comprises adding or removing at least one indicator representing the selected at least one insurance-related product within the collapsible menu.

14. The method of claim 13, wherein the at least one indicator comprises an icon.

15. The method of claim 13, wherein the at least one indicator comprises a first indicator, and the collapsible menu further displays a second indicator based on historical data of the user.

16. The method of claim 15, wherein the selected at least one insurance-related product comprises a first insurance-related product, and the historical data of the user comprises a second insurance-related product selected by the user.

17. The method of claim 11, further comprising, upon receiving from the user the selection of the at least one insurance-related product in the plurality of insurance-related products:
generating a questionnaire for customizing insurance service products based on the selected at least one insurance-related product;
providing the questionnaire on the user interface; and
receiving a user input in response to the questionnaire.

18. The method of claim 17, wherein the questionnaire requests information associated with at least one user insurance risk factor.

19. The method of claim 18, wherein the user insurance risk factor is associated with at least one of a demographic of the user, a location of the user, a residence of the user, a vehicle of the user, a credit history of the user, an accident report of the user, a police record of the user, an insurance history report of the user, a record or report on a vehicle associated with the user, or a record or report on a residence associated with the user.

20. The method of claim 17, wherein determining the custom insurance product is further based on the received user input.
